(19) United States
(12) Patent Application Publication
(10) Pub. No.: US 2015/0019384 A1
(43) Pub. Date: Jan. 15, 2015

(54) DIRECT SALE AND SOCIAL NETWORKING PLATFORM AND SYSTEM

(71) Applicant: Eastern Vision, Ltd., Wanchai (HK)

(72) Inventors: Lorand Peter Fabian, Clearwater, FL (US); Michael Holstein, Clearwater, FL (US)

(21) Appl. No.: 14/328,651

(22) Filed: Jul. 10, 2014

Related U.S. Application Data
(60) Provisional application No. 61/845,300, filed on Jul. 11, 2013.

(51) Int. Cl. G06Q 30/06; G06Q 10/08

(52) U.S. Cl. CPC G06Q 30/0635; G06Q 10/0833
USPC 705/26.81

(57) ABSTRACT

Platforms, systems, media, and methods that enable a direct sale of a product or a service comprising a processor configured to provide an application comprising: a software module for the user or the group of users to purchase a product directly from a manufacturer, provided that the buyer has the option to purchase the product from at least two manufacturers; a software module for selecting a shipping service for the product, provided that shipping is from the manufacturer to the user or the group of users, and provided that the user or the group of users has the option to purchase the service from at least two shipping providers; a software module for tracking the product through the manufacturing and shipping processes; and a software module for social networking comprises directly connecting to the manufacturer, the shipping provider, other users, or other group of users.

### CROSS-REFERENCE TO RELATED APPLICATIONS

The present application is a non-provisional of, and claims the benefit of U.S. Provisional Application No. 61/845,300 filed on Jul. 11, 2013, the entire contents of which are incorporated herein by reference.

### BACKGROUND OF THE INVENTION

Online shopping is gaining tremendous popularity around the world with the wide spread use of the Internet and smart mobile devices. Online shopping is readily attracting a much higher volume of consumers than traditional “brick and mortar” physical stores. In the existing online shopping regime, most of the online shops provide hosting services to distributors and/or retailers. As a result, the total amount that a consumer pays for acquiring a piece of merchandise inevitably includes invisible or indirect costs from distributor or retailer services, and/or online hosting charges.

### SUMMARY OF THE INVENTION

The instant inventors have identified that existing online shopping websites in that they fail to provide adequate and efficient opportunities for direct sales from manufacturers to customers. With the current available online shopping services, a customer typically has to purchase a product from a distributor or retailer with additional invisible or indirect charges from them or the online websites. Furthermore, the customer has to spend extra time waiting for the merchandise to arrive as it is transported first from a manufacturer to the distributor or retailer. Another disadvantage associated with buying from an online distributor or retailer identified by the instant inventors is that it is not convenient to obtain post-sale services, if any are provided in the first instance. Additionally, existing online shopping websites are unable to provide direct and efficient communication between different stakeholders of the shopping network, i.e., manufacturer, shipping provider, and consumer, which needs to be achieved with separate social networking websites.

One advantage of the direct sale and social networking platform described herein is to enable direct sale of merchandise from a manufacturer to a customer. Other advantages of the platform described herein are elimination of invisible or indirect costs and shortening of merchandise transportation time. As a result, customers can shop for online merchandise with reduced total cost and faster delivery. Additional, the platform described herein allows the manufacturer to make more revenue by removing the charges associated with the service of a distributor or retailer. The manufacturer also gains direct interaction with customers for acquiring feedback and solicitation of additional products and/or services; while the customers gain direct connection with manufacturers for possible post-sale services. Furthermore, the described direct sale and social networking platform enables multiple stakeholders of the online shopping system to communicate directly and efficiently, which may in return facilitate the effective functioning of the online shopping platform. Moreover, the consumer ultimately benefits with the subject matter described herein with an increased ability to obtain competitive pricing for goods and services, and also competitive pricing for efficient shipping services. Further, the consumer has the capability, in certain embodiments, to track the delivery of ordered items through the supply channels.

In one aspect, disclosed herein are computer-implemented platforms, systems, or devices for a direct sale to a user or a group of users comprising a processor configured to provide a consumer application comprising: a software module for the user or the group of users to purchase a product directly from a manufacturer of the product, provided that the user or the group of users has the option to purchase the product from at least two manufacturers; a software module for selecting a shipping service from a shipping provider for the product, provided that shipping is from the manufacturer to the user or the group of users, and provided that the user or the group of users has the option to purchase the shipping service from at least two shipping providers; a software module for tracking the product through the manufacturing and shipping processes; and a software module for social networking, provided that social networking comprises directly connecting to the manufacturer, the shipping provider, a different user, or a different group of users. In some embodiments, the consumer is the user or the group of users. In some embodiments, the user is a person, a group of people, or a company that uses the social network. In some embodiments, the product is a piece of merchandise, a service, or the like. In some embodiments, the processor configured to provide the consumer application further comprises a software module for creating or managing a profile. In further embodiments, the profile is of the consumer. In further embodiments, the profile comprises a name, an address, a phone number, an email, a website, or a description. In some embodiments, the processor configured to provide the consumer application further comprises a software module for searching. In further embodiments, the searching is for the product, a catalog, a rating, the user, or the group of users. In further embodiments, the searching comprises searching a database of the platform or a third-party. In further embodiments, the catalog comprises a name, a number, a description, or a price of the product. In further embodiments, the number is a catalog number, a series number, a barcode, or the like. In further embodiments, the description comprises a written, graphic, audio, or video description. In further embodiments, the description comprises a name, a dimension, a weight, a feature, a price, an expiration date, or a user manual. In further embodiments, the rating is of the product, the catalog, the user, or the group of users. In further embodiments, the rating comprises a score, a review, a survey, a multiple-choice selection, a single-choice selection, or the like. In some embodiments, the processor configured to provide the consumer application further comprises a software module for comparing price of the product. In further embodiments, the price comprises cost of the product, national tax, customs tax, insurance, cost of shipping, or additional charges. In some embodiments, the processor configured to provide the consumer application further comprises a software module for viewing or adding a rating of the product, a catalog, the user, or the group of the users. In some embodiments, the processor configured to provide the consumer application further comprises a software module for placing an order. In some embodiments, the processor configured to provide the consumer application further comprises a software module for receiving a shipping quote from a shipping provider. In some embodiments, the processor configured to provide the consumer application further comprises a software module for sending a shipping request to a shipping provider, provided that the shipping provider is selected by the user or the group of users. In further embodiments, the shipping request comprises the recipient name, delivery address, delivery time, or shipping cost. In further embodiments, the shipping request further comprises a shipping route. In some embodiments, the tracking is via a barcode. In further embodiments, the barcode is unique to an order. In some embodiments, the processor configured to provide the consumer application further comprises a software module for requesting customer service. In further embodiments, the request is real-time. In further embodiments, the customer service comprises an inquiry, maintenance, a repair, an exchange, a replacement, a return, a refund, or the like. In some embodiments, the processor configured to provide the consumer application further comprises a software module for managing and analyzing data, provided that data are related to the direct sale. In some embodiments, social networking influences the shopping, shipping, selling and tracking behavior of the direct sale. In other embodiments, social networking influences the selection of the manufacturer, the shipping provider, the product, the shipping service, the different user, or the different group of users in the direct sale. In some embodiments, the social networking comprises sending or allowing a request to or from the user or the group of users, communicating with the user or the group of users, or the like. In further embodiments, the request is for joining the group of users, accessing a profile of the user, communicating with the user or the group of users, or the like. In further embodiments, the communication is a posting, a text message, a graphic message, a voice message, an email, an online chat, or the like.

In another aspect, described herein are computer-implemented methods of a direct sale of a product from a manufacturer to a user or a group of users that comprises: providing, by a computer, an interface for purchasing a product directly from a manufacturer, provided that the user or the group of users has the option to purchase the product from at least two manufacturers; providing, by the computer, an interface for selecting a shipping service from a shipping provider for the product, provided that the shipping is from the manufacturer to the user or the group of users, and provided that the user or the group of users has the option to purchase a shipping service from at least two shipping providers; providing, by the computer, an interface for tracking the product through the manufacturing and shipping processes; and providing, by the computer, an interface for accessing a social network, provided that social networking comprises directly connecting to the manufacturer, the shipping provider, a different user, or a different group of users. In some embodiments, the product comprises a piece of merchandise, a service, or the like. In some embodiments, the consumer is the user or the group of users. In some embodiments, the user is a person, a group of people, or a company. In some embodiments, the method further comprises creating or managing a profile. In further embodiments, the profile comprises a name, an address, a phone number, an email, a website, or a description of the user or the group of users. In some embodiments, the method further comprises searching a database of the platform or a third-party. In further embodiments, the searching is for the product, a catalog, a rating, the user, or the group of users. In further embodiments, the catalog comprises a name, a catalog number, a series number, a barcode, a description, or a price of the product. In some embodiments, the method further comprises comparing prices of the product. In further embodiments, the price comprises cost of the product, national tax, customs tax, cost of insurance, cost of shipping, or additional charges. In some embodiments, the method further comprises a software module for viewing or adding a rating of the product, a catalog, the user, or the group of users. In further embodiments, the rating is of the product, the catalog, the user, or the group of users. In further embodiments, the rating comprises a score, a review, a survey, a multiple-choice selection, a single-choice selection, or the like. In some embodiments, the method further comprises placing an order. In some embodiments, the method further comprises receiving a shipping quote from a shipping provider. In some embodiments the method further comprises sending a shipping request to a shipping provider, provided that the shipping provider is selected by the user or the group of users. In further embodiments, the shipping request comprises a recipient name, a delivery address, a delivery time, a shipping content, or a shipping cost. In further embodiments, the shipping request further comprises a shipping route. In some embodiments, the tracking is via a barcode. In further embodiments, the barcode is unique to an order. In some embodiments, the method further comprises sending or receiving a request for customer service. In further embodiments, the request is real-time. In further embodiments, the customer service comprises an inquiry, maintenance, a repair, an exchange, a replacement, a return, a refund, or the like. In some embodiments, the method further comprises managing and analyzing data, provided that data are related to the direct sale. In some embodiments, accessing a social network influences the shopping, shipping, selling and tracking behavior of the direct sale. In other embodiments, accessing a social network influences the selection of the manufacturer, the shipping provider, the product, the shipping service, the different user, or the different group of users in the direct sale. In some embodiments, accessing the social network comprises sending or allowing a request to or from the user or the group of users, communicating with the user or the group, or the like. In further embodiments, the request is for joining the group of users, accessing a profile of the user, communicating with the user or the group of users, or the like. In further embodiments, the communication is a posting, a text message, a graphic message, a voice message, an email, an online chat, or the like.

In another aspect, described herein are non-transitory computer-readable storage media encoded with a computer program including instructions executable by a processor to create a consumer application comprising: a software module for the user or the group of users to purchase a product directly from a manufacturer of the product, provided that the user or the group of users has the option to purchase the product from at least two manufacturers; a software module for selecting a shipping service from a shipping provider for the product, provided that shipping is from the manufacturer to the user or the group of users, and provided that the user or the group of users has the option to purchase the shipping service from at least two shipping providers; a software module for tracking the product through the manufacturing and shipping processes; and a software module for social networking, provided that social networking comprises directly connecting to the manufacturer, the shipping provider, a different user, or a different group of users In some embodiments, the consumer is the user or the group of users. In some embodiments, the user is a person, a group of people, or a company that uses the social network. In some embodiments, the product is a piece of merchandise, a service, or the like. In some embodiments, the processor configured to provide the consumer application further comprises a software module for creating or managing a profile. In further embodiments, the profile is of the consumer. In further embodiments, the profile comprises a name, an address, a phone number, an email, a website, or a description. In some embodiments, the processor configured to provide the consumer application further comprises a software module for searching. In further embodiments, the searching is for the product, a catalog, a rating, the user, or the group of users. In further embodiments, the searching comprises searching a database of the platform or a third-party. In further embodiments, the catalog comprises a name, a number, a description, or a price of the product. In further embodiments, the number is a catalog number, a series number, a barcode, or the like. In further embodiments, the description comprises a written, graphic, audio, or video description. In further embodiments, the description comprises a name, a dimension, a weight, a feature, a price, an expiration date, or a user manual. In further embodiments, the rating is of the product, the catalog, the user, or the group of users. In further embodiments, the rating comprises a score, a review, a survey, a multiple-choice selection, a single-choice selection, or the like. In some embodiments, the processor configured to provide the consumer application further comprises a software module for comparing price of the product. In further embodiments, the price comprises cost of the product, national tax, customs tax, insurance, cost of shipping, or additional charges. In some embodiments, the processor configured to provide the consumer application further comprises a software module for viewing or adding a rating of the product, a catalog, the user, or the group of the users. In some embodiments, the processor configured to provide the consumer application further comprises a software module for placing an order. In some embodiments, the processor configured to provide the consumer application further comprises a software module for receiving a shipping quote from a shipping provider. In some embodiments, the processor configured to provide the consumer application further comprises a software module for sending a shipping request to a shipping provider, provided that the shipping provider is selected by the user or the group of users. In further embodiments, the shipping request comprises the recipient name, delivery address, delivery time, or shipping cost. In further embodiments, the shipping request further comprises a shipping route. In some embodiments, the tracking is via a barcode. In further embodiments, the barcode is unique to an order. In some embodiments, the processor configured to provide the consumer application further comprises a software module for requesting customer service. In further embodiments, the request is real-time. In further embodiments, the customer service comprises an inquiry, maintenance, a repair, an exchange, a replacement, a return, a refund, or the like. In some embodiments, the processor configured to provide the consumer application further comprises a software module for managing and analyzing data, provided that data are related to a direct sale. In some embodiments, social networking influences the shopping, shipping, selling and tracking behavior of the direct sale. In other embodiments, social networking influences the selection of the manufacturer, the shipping provider, the product, the shipping service, the different user, or the different group of users in the direct sale. In some embodiments, the social networking comprises sending or allowing a request to or from the user or the group of users, communicating with the user or the group of users, or the like. In further embodiments, the request is for joining the group of users, accessing a profile of the user, communicating with the user or the group of users, or the like. In further embodiments, the communication is a posting, a text message, a graphic message, a voice message, an email, an online chat, or the like.

In another aspect, disclosed herein are computer-implemented platforms, systems, and devices for a direct sale to a user comprising a processor configured to provide a manufacturer application comprising: a software module for the manufacturer to directly sell a product to a user or a group of users; a software module for shipping the product, provided that shipping is from the manufacturer to the user or the group of users, and provided that the user or the group of users has the option to purchase a shipping service from at least two shipping providers; a software module for tracking the product through the manufacturing and shipping processes; and a software module for social networking, provided that social networking comprises directly connecting to a different manufacturer, the shipping provider, the user, or the group of users. In certain embodiments, the product is a piece of merchandise, service, or the like. In some embodiments, the consumer is the user or the group of users. In certain embodiments, the user is a person, a group of people, or a company. In some embodiments, the processor configured to provide the manufacturer application further comprises a software module for creating or managing a profile. In further embodiments, the profile comprises a name, an address, a phone number, an email, a website, or a description of the manufacturer. In some embodiments, the processor configured to provide the manufacturer application further comprises a software module for creating a catalog. In further embodiments, the catalog comprises a name, a number, a description, or a price of the product. In further embodiments, the number is a catalog number, a series number, a barcode, or the like. In further embodiments, the description comprises a written, graphic, audio, or video description. In further embodiments, the description comprises a name, a dimension, a weight, a feature, a price, an expiration date, or a user manual. In some embodiments, the processor configured to provide the manufacturer application further comprises a software module for receiving an order. In some embodiments, the processor configured to provide the manufacturer application further comprises a software module for sending a shipping request to a shipping provider, provided that the shipping provider is selected by the user or the group of users. In further embodiments, the shipping provider comprises a person or a group of people, or a company that provides shipping service, freight service, transportation service, or the like. In further embodiments, the shipping request comprises a recipient name, a delivery address, a delivery time, a shipping content, or a shipping cost. In further embodiments, the shipping request further comprises a shipping route. In some embodiments, the tracking is via a barcode. In further embodiments, the barcode is unique to an order. In certain embodiments, the processor configured to provide the manufacturer application further comprises a software module for receiving a request for customer service. In further embodiments, the request is real-time. In further embodiments, the customer service comprises an inquiry, maintenance, a repair, an exchange, a replacement, a return, a refund, or the like. In some embodiments, the processor configured to provide the manufacturer application further comprises a software module for viewing a data analytic. In further embodiments, the data analytic comprises statistical, mathematical, logistic, logical, empirical analysis, or the like. In further embodiments, the data analytic is for the product, a catalog, a rating, the user, a profile of the user, or the group of users. In further embodiments, the rating is of the product, the catalog, the user, or the group of users. In further embodiments, the rating comprises a score, a review, a survey, a multiple-choice selection, a single-choice selection, or the like. In certain embodiments, the processor configured to provide the manufacturer application further comprises a software module for managing a resource. In further embodiments, the resource comprises money, a raw material, or an employee. In some embodiments, the processor configured to provide the manufacturer application further comprises a software module for creating and implementing a business plan. In further embodiments, a business plan is a marketing campaign. In further embodiments, the marketing campaign comprises a promotion, a free trial, an advertisement, a gift with purchase, a rebate, a referral, or the like. In certain embodiments, the processor configured to provide the manufacturer application further comprises a software module for viewing or adding a rating of the product, a catalog, the user, or the group of users. In certain embodiments, the processor configured to provide the manufacturer application further comprises a software module for searching. In further embodiments, the searching comprises searching a database of the platform or a third-party. In further embodiments, the searching is for the product, a catalog, a rating, the user, or the group of users. In some embodiments, social networking influences the shopping, shipping, selling and tracking behavior of the direct sale. In other embodiments, social networking influences the selection of the different manufacturer, the shipping provider, the product, the shipping service, the user, or the group of users in the direct sale. In certain embodiments, the social networking comprises sending or allowing a request to or from the user or the group of users, communicating with the user or the group of users, or the like. In further embodiments, the request is for joining the group of users, accessing a profile of the user, communicating with the user or group of users, or the like. In further embodiments, the communication is a posting, a text message, a graphic message, a voice message, an email, an online chat, or the like.

In another aspect, described herein are computer-implemented methods of a direct sale of a product from a manufacturer to a user or a group of users that comprises: providing, by a computer, an interface for selling a product directly from the manufacturer to a user or a group of users, provided that the user or the group of users has the option to purchase the product from at least two manufacturers; and providing, by the computer, an interface for shipping the product; provided that shipping is from the manufacturer to the user or the group of users, and provided that the user or the group of users has the option to purchase a shipping service from at least two shipping providers; and providing, by the computer, an interface for tracking the product through the manufacturing and shipping processes; and providing, by the computer, an interface for accessing a social network, provided that social networking comprises directly connecting to a different manufacturer, the shipping provider, the user, or the group of users. In some embodiments, the product comprises a piece of merchandise, service, or the like. In some embodiments, the user is a person, a group of people, or a company that uses the social network. In some embodiments, the method further comprises creating or managing a profile. In further embodiments, the profile comprises a name, an address, a phone number, an email, a website, or a description of the user or the group of users. In some embodiments, the method further comprises creating a catalog of the product. In further embodiments, the catalog comprises a name, a number, a description, or a price of the product. In further embodiments, the number is a catalog number, a series number, a barcode, or the like. In further embodiments, the description comprises a written, graphic, audio, or video description. In further embodiments, the description comprises a name, a dimension, a weight, a feature, a price, an expiration date, or a user manual. In some embodiments, the method further comprises receiving an order. In some embodiments, the method further comprises sending a shipping request to a shipping provider, provided that the shipping provider is selected by the user or the group of users. In further embodiments, the shipping request comprises a recipient name, a delivery address, a delivery time, a shipping content, or a shipping cost. In further embodiments, the shipping request further comprises a shipping route. In some embodiments, tracking is via a barcode. In further embodiments, the barcode is unique to an order. In some embodiments, the method further comprises receiving a request for customer service. In further embodiments, the request is real-time. In further embodiments, the customer service comprises an inquiry, maintenance, a repair, an exchange, a replacement, a return, a refund, or the like. In some embodiments, the method further comprises viewing a data analytic. In further embodiments, the data analytic comprises statistical, mathematical, logistic, logical, empirical analysis, or the like. In further embodiments, the data analytic is for the product, a catalog, a rating, the user, a profile of the user, or the group of users. In further embodiments, the rating is of the product, the catalog, the user, or the group of users. In further embodiments, the rating comprises a score, a review, a survey, a multiple-choice selection, a single-choice selection, or the like. In some embodiments, the method further comprises managing a resource. In further embodiments, the resource comprises money, a raw material, or an employee. In some embodiments, the method further comprises creating and implementing a business plan. In further embodiments, the business plan is a marketing campaign. In further embodiments, the marketing campaign comprises a promotion, a free trial, an advertisement, a gift with purchase, a rebate, a referral, or the like. In some embodiments, the method further comprises viewing or adding a rating of the product, a catalog, the user or the group of users. In some embodiments, the method further comprises searching a database of the platform or a third-party. In further embodiments, the searching is for the product, a catalog, a rating, the user, or the group of users. In some embodiments, accessing a social network influences the shopping, shipping, selling and tracking behavior of the direct sale. In other embodiments, accessing a social network influences the selection of the different manufacturer, the shipping provider, the product, the shipping service, the user, or the group of users in the direct sale. In some embodiments, accessing the social network comprises sending or allowing a request to or from the user or the group of users, communicating with the user or the group of users, or the like. In further embodiments, the request is for joining the group of users, accessing a profile of the user, communicating with the user or group of users, or the like. In further embodiments, the communication is a posting, a text message, a graphic message, a voice message, an email, an online chat, or the like.

In another aspect, described herein are non-transitory computer-readable storage media encoded with a computer program including instructions executable by a processor to create a manufacturer application comprising: a software module for the manufacturer to directly sell a product to a user or a group of users; a software module for shipping the product, provided that shipping is from the manufacturer to the user or the group of users, and provided that the user or the group of users has the option to purchase a shipping service from at least two shipping providers; a software module for tracking the product through the manufacturing and shipping processes; and a software module for social networking, provided that social networking comprises directly connecting to a different manufacturer, the shipping provider, the user, or the group of users. In certain embodiments, the product is a piece of merchandise, service, or the like. In certain embodiments, the user is a person, a group of people, or a company. In some embodiments, the processor configured to provide the manufacturer application further comprises a software module for creating or managing a profile. In further embodiments, the profile comprises a name, an address, a phone number, an email, a website, or a description of the manufacturer. In some embodiments, the processor configured to provide the manufacturer application further comprises a software module for creating a catalog. In further embodiments, the catalog comprises a name, a number, a description, or a price of the product. In further embodiments, the number is a catalog number, a series number, a barcode, or the like. In further embodiments, the description comprises a written, graphic, audio, or video description. In further embodiments, the description comprises a name, a dimension, a weight, a feature, a price, an expiration date, or a user manual. In some embodiments, the processor configured to provide the manufacturer application further comprises a software module for receiving an order. In some embodiments, the processor configured to provide the manufacturer application further comprises a software module for sending a shipping request to a shipping provider, provided that the shipping provider is selected by the user or the group of users. In further embodiments, the shipping provider comprises a person or a group of people, or a company that provides shipping service, freight service, transportation service, or the like. In further embodiments, the shipping request comprises a recipient name, a delivery address, a delivery time, a shipping content, or a shipping cost. In further embodiments, the shipping request further comprises a shipping route. In some embodiments, the tracking is via a barcode. In further embodiments, the barcode is unique to an order. In certain embodiments, the processor configured to provide the manufacturer application further comprises a software module for receiving a request for customer service. In further embodiments, the request is real-time. In further embodiments, the customer service comprises an inquiry, maintenance, a repair, an exchange, a replacement, a return, a refund, or the like. In some embodiments, the processor configured to provide the manufacturer application further comprises a software module for viewing a data analytic. In further embodiments, the data analytic comprises statistical, mathematical, logistic, logical, empirical analysis, or the like. In further embodiments, the data analytic is for the product, a catalog, a rating, the user, a profile of the user, or the group of users. In further embodiments, the rating is of the product, the catalog, the user, or the group of users. In further embodiments, the rating comprises a score, a review, a survey, a multiple-choice selection, a single-choice selection, or the like. In certain embodiments, the processor configured to provide the manufacturer application further comprises a software module for managing a resource. In further embodiments, the resource comprises money, a raw material, or an employee. In some embodiments, the processor configured to provide the manufacturer application further comprises a software module for creating and implementing a business plan. In further embodiments, a business plan is a marketing campaign. In further embodiments, the marketing campaign comprises a promotion, a free trial, an advertisement, a gift with purchase, a rebate, a referral, or the like. In certain embodiments, the processor configured to provide the manufacturer application further comprises a software module for viewing or adding a rating of the product, a catalog, the user, or the group of users. In certain embodiments, the processor configured to provide the manufacturer application further comprises a software module for searching. In further embodiments, the searching comprises searching a database of the platform or a third-party. In further embodiments, the searching is for the product, a catalog, a rating, the user, or the group of users. In some embodiments, social networking influences the shopping, shipping, selling and tracking behavior of the direct sale. In other embodiments, social networking influences the selection of the different manufacturer, the shipping provider, the product, the shipping service, the user, or the group of users in the direct sale. In certain embodiments, the social networking comprises sending or allowing a request to or from the user or the group of users, communicating with the user or the group of users, or the like. In further embodiments, the request is for joining the group of users, accessing a profile of the user, communicating with the user or group of users, or the like. In further embodiments, the communication is a posting, a text message, a graphic message, a voice message, an email, an online chat, or the like.

In another aspect, disclosed herein are computer-implemented platforms, systems, or devices for a direct sale to a user or a group of users comprising a processor configured to provide a shipping provider application comprising: a software module for shipping a product from a manufacturer to the user or the group of users, provided that the user or the group of users has the option to purchase a shipping service from at least two shipping providers; and a software module for tracking the product from the manufacturer to the user or the group of users; provided that at least one of the manufacturer, the shipping provider, the user, or the group of users is a member of a social network. In some embodiments, the shipping provider is a person, a group of people, or a company that provides merchandise shipping, delivery, freight, or transportation service and uses the social network. In some embodiments, the product is a piece of merchandise, service, or the like. In some embodiments, the user is a person, a group of people, or a company that uses the social network. In some embodiments, the group comprises one or more users of the social network. In certain embodiments, the processor configured to provide the manufacturer application further comprises a software module for creating or managing a profile. In further embodiments, the profile is of the shipping provider. In further embodiments, the profile comprises a name, an address, a phone number, an email, a website, or a description. In certain embodiments, the processor configured to provide the manufacturer application further comprises a software module for receiving a shipping request. In further embodiments, the shipping request comprises the recipient name, delivery address, delivery time, or shipping cost. In certain embodiments, the processor configured to provide the manufacturer application further comprises a software module for generating a shipping quote. In further embodiments, the shipping quote comprises cost of shipping, tax, or additional service charges. In certain embodiments, the processor configured to provide the manufacturer application further comprises a software module for route planning. In further embodiments, the route planning is based on distance, toll, real-time traffic, route speed limit, or user preferences. In certain embodiments, the processor configured to provide the manufacturer application further comprises a software module for generating a barcode. In further embodiments, the barcode is unique to a shipment. In certain embodiments, the tracking is via the barcode. In certain embodiments, the processor configured to provide the manufacturer application further comprises a software module for receiving a request for customer service. In further embodiments, the request is real-time. In further embodiments, the customer service comprises an inquiry, maintenance, a repair, an exchange, a replacement, a return, a refund, or the like. In certain embodiments, the processor configured to provide the manufacturer application further comprises a software module for viewing a data analytic. In further embodiments, the data analytic comprises statistical, mathematical, logistic, logical, empirical analysis, or the like. In further embodiments, the data analytic is for the product, a catalog, a rating, the user, a profile of the user, or the group of users. In further embodiments, the catalog comprises a name, a number, a description, or a price of the product. In further embodiments, the number is a catalog number, a series number, a barcode, or the like. In further embodiments, the description comprises a written, graphic, audio, or video description. In further embodiments, the description comprises a name, a dimension, a weight, a feature, a price, an expiration date, or a user manual. In further embodiments, the rating is of the product, the catalog, the user, or the group of users. In further embodiments, the rating comprises a score, a review, a survey, a multiple-choice selection, a single-choice selection, or the like. In certain embodiments, the processor configured to provide the manufacturer application further comprises a software module for managing a resource. In further embodiments, the resource comprises money, a raw material, or an employee. In certain embodiments, the processor configured to provide the manufacturer application further comprises a software module for creating and implementing a business plan. In further embodiments, the business plan is a marketing campaign. In further embodiments, the marketing campaign comprises a promotion, a free trial, an advertisement, a gift with purchase, a rebate, a referral, or the like. In certain embodiments, the processor configured to provide the manufacturer application further comprises a software module for creating the group. In further embodiments, the group is open or needs a permission to join. In further embodiments, the permission is granted by the user. In certain embodiments, the processor configured to provide the manufacturer application further comprises a software module for viewing or adding a rating of the product, a catalog, the user, or the group of users. In certain embodiments, the processor configured to provide the manufacturer application further comprises a software module for searching. In further embodiments, the searching comprises searching a database of the platform or a third-party. In further embodiments, the searching is for the product, a catalog, a rating, the user, or the group of users. In some embodiments, social networking influences the shopping, shipping, selling and tracking behavior of the direct sale. In other embodiments, social networking influences the selection of the manufacturer, the different shipping provider, the product, the shipping service, the user, or the group of users in the direct sale. In some embodiments, the social networking comprises sending or allowing a request to or from the user or the group, communicating with the user or the group, or the like. In further embodiments, the request is for joining the group, accessing a profile of the user, communicating with the user or group, or the like. In further embodiments, the communication is a posting, a text message, a graphic message, a voice message, an email, an online chat, or the like.

Provided herein is a worldwide business network, an online, real time platform, where businesses meet to create their own network of distribution and delivery. In some embodiments, each participant creates a profile just like on a social network, gives the description of the company, genuine and verifiable information, and uploads pictures or a video of the company and other promotional information. In further embodiments, each participant is categorized by branch within an industry, such as Production Company, Freight Company, Freight Forwarding Company, and the like. In still further embodiments, each participant builds their own network throughout the world and makes business connections that are visible on their own profiles. In some embodiments, companies that are in a “network” and do business together, rate each other's services in a “five star” rating system, adding a comment as to why in a chronological order. In further embodiments, the larger someone's network is, the higher the ratings and they attract more business. In this way, the networks grow and companies can see each other's ratings, which provide a picture of the business and its capabilities. The web site and the profiles described herein are highly accessible through the main website, downloadable mobile apps, and feeds into existing websites. In some embodiments, the subject matter described herein provides a web site that creates barcodes and works with a mobile application enabling any chaffer to do any transaction, including a pickup, or a transfer, or a delivery to the customer. In further embodiments, all of the relevant information is available in real time on the website so that the customer can track the location of his goods. The combination and the blending of these elements in this particular order: GPS technology, mobile communication technology, and server applications allows the subject matter described herein to offer many advantages. In some embodiments, the subject matter described herein provides specific services via modules to members that would want to use those services. In further embodiments, the modules are individual software solutions that are geared to simplify a business' process and to offer the company a vital expansion tool at a fraction of the cost compared to a software solution that has to be purchased and installed. As these modules are, in some embodiments, an online solution, a user will only have a minimal hardware requirement and cost associated with it, enabling small companies to benefit from software solutions that historically would only be available to companies that can afford them giving the small company an extra help.

In another aspect, disclosed herein are direct shipping platforms comprising: a server processor configured to provide a web application for a production user or a freight user comprising: a software module for presenting a user interface, the user interface providing access to: a software module for creating and managing a profile, the profile comprising a user type, the user types comprising at least one production user type and at least one freight user type, a software module for connecting profiles to form a network, and a software module for rating user services. In some embodiments, the at least one freight user type is selected from: freight forwarder and freight transporter. In some embodiments, the at least one production user type is selected from: manufacturer and supplier. In some embodiments, the profiles are connected by an invitation and response process. In some embodiments, for the production user, the software module for presenting a user interface further provides access to: a software module for generating a barcode, the barcode comprising a barcode type and a software module for generating a shipping request for a particular shipment, the request directed to an in-network freight user or to a bidding module where no in-network freight user exists. In further embodiments, the barcode type is selected from: a production barcode, a parcel barcode, and a shipping barcode. In further embodiments, the barcode type is a shipping barcode and the barcode includes shipping information comprising one or more of: origin information, destination information, inventory information, tax information, insurance information, and customs information. In various embodiments, the barcode is a linear barcode, a two-dimensional barcode, or a high capacity color barcode. In some embodiments, the platform further comprises at least one mobile processor configured to provide a mobile application for the freight user, the application comprising: a software module for reading a barcode and accessing shipping information contained therein; and a software module for capturing a signature in association with fulfillment of a shipping request. In some embodiments, for the freight user, the software module for presenting a user interface further provides access to: a software module for receiving a shipping request for a particular shipment from an in-network production user and a software module for bidding on shipping requests from an out-of-network production user. In further embodiments, the software module for bidding on shipping requests allows a user to bid on a portion of the shipping request. In further embodiments, for the freight user, the software module for presenting a user interface further provides access to a software module for generating a barcode, the barcode comprising a barcode type. In some embodiments, the platform is extensible offering user-selectable inclusion of one or more of: a production module, an accounting module, a fulfillment module, a sales module, and an e-marketing module, for a production user. In some embodiments, the platform is extensible offering user-selectable inclusion of one or more of: an accounting module, a route preparation module, a sales module, and an e-marketing module, for a freight user. In further embodiments, the route preparation module incorporates the knowledge of individual drivers of particular areas or routes. In further embodiments, the route preparation module incorporates individual parcel information to prepare vehicle loading guidance. In some embodiments, the software module for rating user services allows rating other users with membership in a common network. In some embodiments, the rating comprises at least one comment. In some embodiments, the rating is on a five star scale. In some embodiments, the software module for presenting a user interface further provides access to a software module for searching profiles. In some embodiments, the application further comprises a software module for advertising third-party goods and services.

In another aspect, disclosed herein are direct shipping platforms comprising: a server processor configured to provide an application for a production user or a freight user comprising: a software module for presenting a user interface, the user interface providing access to: a software module for creating and managing a profile, the profile comprising a user type, the user types comprising at least one production user type and at least one freight user type, a software module for connecting profiles to form a network, and a software module for rating user services; for the production user, a software module for generating a barcode, the barcode comprising a barcode type and a software module for generating a shipping request for a particular shipment, the request directed to an in-network freight user or to a bidding module where no in-network freight user exists; and for the freight user, a software module for receiving a shipping request for a particular shipment from an in-network production user and a software module for bidding on shipping requests from an out-of-network production user; at least one mobile processor configured to provide a mobile application for the freight user, the application comprising: a software module for reading a barcode and accessing shipping information contained therein; and a software module for capturing a signature in association with fulfillment of a shipping request. In some embodiments, the at least one freight user type is selected from: freight forwarder and freight transporter. In some embodiments, the at least one production user type is selected from: manufacturer and supplier. In some embodiments, the profiles are connected by an invitation and response process. In some embodiments, the platform is extensible offering user-selectable inclusion of one or more of: a production module, an accounting module, a fulfillment module, a sales module, and an e-marketing module, for a production user. In some embodiments, the platform is extensible offering user-selectable inclusion of one or more of: an accounting module, a route preparation module, a sales module, and an e-marketing module, for a freight user. In further embodiments, the route preparation module incorporates the knowledge of individual drivers of particular areas or routes. In further embodiments, the route preparation module incorporates individual parcel information to prepare vehicle loading guidance. In some embodiments, the barcode type is selected from: a production barcode, a parcel barcode, and a shipping barcode. In some embodiments, the barcode type is a shipping barcode and the barcode includes shipping information comprising one or more of: origin information, destination information, inventory information, tax information, insurance information, and customs information. In various embodiments, the barcode is a linear barcode, a two-dimensional barcode, or a high capacity color barcode. In some embodiments, the software module for bidding on shipping requests allows a user to bid on a portion of the shipping request. In some embodiments, the software module for rating user services allows rating other users with membership in a common network. In some embodiments, the rating comprises at least one comment. In some embodiments, the rating is on a five star scale. In some embodiments, for the freight user, the user interface further provides access to a software module for generating a barcode, the barcode comprising a barcode type. In some embodiments, the user interface further provides access to a software module for searching profiles. In some embodiments, the application further comprises a software module for advertising third-party goods and services.

In another aspect, disclosed herein are computer-implemented platforms, systems, or devices for social networking comprising a processor configured to provide a member application comprising: a software module for a member or a group of members to directly sale or purchase a product; a software module for shipping the product, provided that the member or the group of members has the option to purchase a shipping service from at least two shipping providers; and a software module for tracking the product; and a software module for social networking. In some embodiments, the member is a person, a group of people, or a company that uses the social network. In some embodiments, the group comprises one or more members of the social network. In certain embodiments, the processor configured to provide the member application further comprises a software module for creating or managing a profile of the member. In further embodiments, the profile comprises a name, an address, a phone number, an email, a website, or a description of the member. In some embodiments, social networking influences the shopping, shipping, selling and tracking behavior of the direct sale. In other embodiments, social networking influences the selection of the manufacturer, the shipping provider, the product, the shipping service, the different member, or the different group of members in the direct sale. In certain embodiments, the processor configured to provide the member application further comprises a software module for creating the group. In further embodiments, the group is open to join or needs a permission to join. In further embodiments, the permission is granted by the member. In certain embodiments, the processor configured to provide the member application further comprises a software module for sending or allowing a request to or from the group or the member. In further embodiments, the request is for joining the group, accessing a profile of the member, communicating with the member, or the like. In some embodiments, the communication is a posting, a text message, a graphic message, a voice message, an email, an online chat, or the like. In certain embodiments, the processor configured to provide the member application further comprises a software module for presenting a catalog of the product. In further embodiments, the catalog comprises a name, a number, a description, or a price of the product. In further embodiments, the number is a catalog number, a series number, a barcode, or the like. In further embodiments, the description comprises a written, graphic, audio, or video description. In further embodiments, the description comprises a name, a dimension, a weight, a feature, a price, an expiration date, or a user manual. In certain embodiments, the processor configured to provide the member application further comprises a software module for comparing prices of the product. In further embodiments, the prices comprise merchandise cost, taxes, shipping cost, or additional charges. In certain embodiments, the processor configured to provide the member application further comprises a software module for viewing or adding a rating of the product, a catalog, the member, or the group of members. In further embodiments, the rating comprises a score, a review, a survey, a multiple-choice selection, a single-choice selection, or the like. In certain embodiments, the processor configured to provide the member application further comprises a software module for placing an order. In certain embodiments, the processor configured to provide the member application further comprises a software module for sending or receiving a shipping request. In further embodiments, the shipping request comprises the recipient name, delivery address, delivery time, and shipping cost. In further embodiments, the shipping request further comprises a shipping route. In certain embodiments, the tracking is via a barcode. In further embodiments, the barcode is unique to an order. In certain embodiments, the processor configured to provide the member application further comprises a software module for requesting customer service. In further embodiments, the request is real-time. In further embodiments, the customer service comprises an inquiry, maintenance, a repair, an exchange, a replacement, a return, a refund, or the like. In certain embodiments, the processor configured to provide the member application further comprises a software module for generating a data analytic. In further embodiments, the data analytics comprises statistical, mathematical, logistic, logical, empirical analysis, or the like. In further embodiments, the data analytic is for the product, a catalog, a rating, the member, a profile of the member, or the group of members. In further embodiments, the rating is of the product, a catalog, the member, or the group of members. In certain embodiments, the processor configured to provide the member application further comprises a software module for managing a resource. In further embodiments, the resource comprises money, a raw material, or an employee. In certain embodiments, the processor configured to provide the member application further comprises a software module for creating and implementing a business plan. In further embodiments, the business plan is a marketing campaign. In further embodiments, the marketing campaign comprises a promotion, a free trial, an advertisement, a gift with purchase, a rebate, a referral, or the like. In another aspect, disclosed herein are computer-implemented platforms, systems, or devices for a direct sale to a user comprising a processor configured to provide an administrator application comprising: a software module for creating or managing a database; and a software module for social networking. In some embodiments, the administrator is a person, a group of people, or a company that uses the social network. In some embodiments, the database is of a product, a catalog, a profile, a rating, a user, or a group of members. In further embodiments, the product is a piece of merchandise, service, or the like. In further embodiments, the catalog comprises a name, a number, a description, or a price of the product. In further embodiments, the profile comprises a name, an address, a phone number, an email, a website, or a description of the user. In further embodiments, the rating is of the product, a catalog, the user, or the group of members. In further embodiments, the rating comprises a score, a review, a survey, a multiple-choice selection, a single-choice selection, or the like. In further embodiments, the user is a person, a group of people, or a company that uses the social network. In further embodiments, the group comprises one or more users of the social network. In some embodiments, the processor configured to provide an administrator application further comprises a software module for categorizing a product into a category. In some embodiments, the processor configured to provide an administrator application further comprises a software module for generating a data analytic. In further embodiments, the data analytic is for a product, a catalog, a profile, a rating, a user, a profile of a user, or a group of members. In further embodiments, the data analytics comprises statistical, mathematical, logistic, logical, empirical analysis, or the like. In certain embodiments, the social networking comprises sending or allowing a request to or from the user or the group, communicating with the user or the group, or the like. In further embodiments, the request is for joining the group, accessing a profile of the user, communicating with the user or group, or the like. In further embodiments, the communication is a posting, a text message, a graphic message, a voice message, an email, an online chat, or the like.

In another aspect, disclosed herein are computer-implemented methods comprising: creating, by a computer, a profile, the profile having a production user type; connecting, by the computer, the profile with at least one other profile to create a network; where the network includes a user with a freight user type, generating, by the computer, a shipping request for a particular shipment, the request directed to an in-network freight user based on membership in a network and an operating area defined in the freight profile; where the network does not include a user with a freight user type, generating, by the computer, a shipping request for a particular shipment, the request directed to a bidding module and receiving, by the computer, bids on the shipping request; generating, by the computer, a shipping barcode and at least one parcel barcode, the barcodes comprising shipping information for the particular shipment; and rating, by the computer, services provided by the freight user.

In another aspect, described herein are non-transitory computer-readable storage media encoded with a computer program including instructions executable by a processor to create a shipping provider application comprising: a software module for shipping a product from a manufacturer to a user or a group of users, provided that the user or the group of users has the option to purchase a shipping service from at least two shipping providers; and a software module for tracking the product from the manufacturer to the user or the group; provided that at least one of the manufacturer, the user, or the group of users is a member of a social network. In some embodiments, the shipping provider is a person, a group of people, or a company that uses the social network and provides merchandise shipping, delivery, freight, or transportation service. In some embodiments, the product is a piece of merchandise, service, or the like. In some embodiments, the user is a person, a group of people, or a company that uses the social network. In some embodiments, the group comprises one or more users of the social network. In certain embodiments, the processor configured to provide the manufacturer application further comprises a software module for creating or managing a profile. In further embodiments, the profile is of the shipping provider. In further embodiments, the profile comprises a name, an address, a phone number, an email, a website, or a description. In certain embodiments, the processor configured to provide the manufacturer application further comprises a software module for receiving a shipping request. In further embodiments, the shipping request comprises the recipient name, delivery address, delivery time, or shipping cost. In certain embodiments, the processor configured to provide the manufacturer application further comprises a software module for generating a shipping quote. In further embodiments, the shipping quote comprises cost of shipping, tax, or additional service charges. In certain embodiments, the processor configured to provide the manufacturer application further comprises a software module for route planning. In further embodiments, the route planning is based on distance, toll, real-time traffic, route speed limit, or user preferences. In certain embodiments, the processor configured to provide the manufacturer application further comprises a software module for generating a barcode. In further embodiments, the barcode is unique to a shipment. In certain embodiments, the tracking is via the barcode. In certain embodiments, the processor configured to provide the manufacturer application further comprises a software module for receiving a request for customer service. In further embodiments, the request is real-time. In further embodiments, the customer service comprises an inquiry, maintenance, a repair, an exchange, a replacement, a return, a refund, or the like. In certain embodiments, the processor configured to provide the manufacturer application further comprises a software module for viewing a data analytic. In further embodiments, the data analytic comprises statistical, mathematical, logistic, logical, empirical analysis, or the like. In further embodiments, the data analytic is for the product, a catalog, a rating, the user, a profile of the user, or the group of users. In further embodiments, the catalog comprises a name, a number, a description, or a price of the product. In further embodiments, the number is a catalog number, a series number, a barcode, or the like. In further embodiments, the description comprises a written, graphic, audio, or video description. In further embodiments, the description comprises a name, a dimension, a weight, a feature, a price, an expiration date, or a user manual. In further embodiments, the rating is of the product, the catalog, the user, or the group of users. In further embodiments, the rating comprises a score, a review, a survey, a multiple-choice selection, a single-choice selection, or the like. In certain embodiments, the processor configured to provide the manufacturer application further comprises a software module for managing a resource. In further embodiments, the resource comprises money, a raw material, or an employee. In certain embodiments, the processor configured to provide the manufacturer application further comprises a software module for creating and implementing a business plan. In further embodiments, the business plan is a marketing campaign. In further embodiments, the marketing campaign comprises a promotion, a free trial, an advertisement, a gift with purchase, a rebate, a referral, or the like. In certain embodiments, the processor configured to provide the manufacturer application further comprises a software module for creating the group. In further embodiments, the group is open or needs a permission to join. In further embodiments, the permission is granted by the user. In certain embodiments, the processor configured to provide the manufacturer application further comprises a software module for viewing or adding a rating of the product, a catalog, the user, or the group of users. In certain embodiments, the processor configured to provide the manufacturer application further comprises a software module for searching. In further embodiments, the searching comprises searching a database of the platform or a third-party. In further embodiments, the searching is for the product, a catalog, a rating, the user, or the group of users. In some embodiments, social networking influences the shopping, shipping, selling and tracking behavior of the direct sale. In other embodiments, social networking influences the selection of the manufacturer, the different shipping provider, the product, the shipping service, the user, or the group of users in the direct sale. In some embodiments, the social networking comprises sending or allowing a request to or from the user or the group, communicating with the user or the group, or the like. In further embodiments, the request is for joining the group, accessing a profile of the user, communicating with the user or group, or the like. In further embodiments, the communication is a posting, a text message, a graphic message, a voice message, an email, an online chat, or the like.

In another aspect, described herein are computer-implemented methods of shipping of a product from a manufacturer to a user or a group of users that comprises: shipping, with assistance of a computer, the product from the manufacturer to the user or the group of users by a shipping provider, provided that the user or the group of users has the option to purchase a shipping service from at least two shipping providers; and tracking, with assistance of a computer, the product from the manufacturer to the user or the group; provided that at least one of the manufacturer, the shipping provider the user, or the group of users is a member of a social network. In some embodiments, the shipping provider is a person, a group of people, or a company that uses the social network and provides merchandise shipping, delivery, freight, or transportation service. In some embodiments, the product is a piece of merchandise, service, or the like. In some embodiments, the user is a person, a group of people, or a company that uses the social network. In some embodiments, the group comprises one or more users of the social network. In certain embodiments, the methods further comprise a software module for creating or managing a profile. In further embodiments, the profile is of the shipping provider. In further embodiments, the profile comprises a name, an address, a phone number, an email, a website, or a description. In certain embodiments, the methods further comprise a software module for receiving a shipping request. In further embodiments, the shipping request comprises the recipient name, delivery address, delivery time, or shipping cost. In certain embodiments, the methods further comprise a software module for generating a shipping quote. In further embodiments, the shipping quote comprises cost of shipping, tax, or additional service charges. In certain embodiments, the methods further comprise a software module for route planning. In further embodiments, the route planning is based on distance, toll, real-time traffic, route speed limit, or user preferences. In certain embodiments, the methods further comprise a software module for generating a barcode. In further embodiments, the barcode is unique to a shipment. In certain embodiments, the tracking is via the barcode. In certain embodiments, the methods further comprise a software module for receiving a request for customer service. In further embodiments, the request is real-time. In further embodiments, the customer service comprises an inquiry, maintenance, a repair, an exchange, a replacement, a return, a refund, or the like. In certain embodiments, the methods further comprise a software module for viewing a data analytic. In further embodiments, the data analytic comprises statistical, mathematical, logistic, logical, empirical analysis, or the like. In further embodiments, the data analytic is for the product, a catalog, a rating, the user, a profile of the user, or the group of users. In further embodiments, the catalog comprises a name, a number, a description, or a price of the product. In further embodiments, the number is a catalog number, a series number, a barcode, or the like. In further embodiments, the description comprises a written, graphic, audio, or video description. In further embodiments, the description comprises a name, a dimension, a weight, a feature, a price, an expiration date, or a user manual. In further embodiments, the rating is of the product, the catalog, the user, or the group of users. In further embodiments, the rating comprises a score, a review, a survey, a multiple-choice selection, a single-choice selection, or the like. In certain embodiments, the methods further comprise a software module for managing a resource. In further embodiments, the resource comprises money, a raw material, or an employee. In certain embodiments, the methods further comprise a software module for creating and implementing a business plan. In further embodiments, the business plan is a marketing campaign. In further embodiments, the marketing campaign comprises a promotion, a free trial, an advertisement, a gift with purchase, a rebate, a referral, or the like. In certain embodiments, the methods further comprise a software module for creating the group. In further embodiments, the group is open or needs a permission to join. In further embodiments, the permission is granted by the user. In certain embodiments, the methods further comprise a software module for viewing or adding a rating of the product, a catalog, the user, or the group of users. In certain embodiments, the methods further comprise a software module for searching. In further embodiments, the searching comprises searching a database of the platform or a third-party. In further embodiments, the searching is for the product, a catalog, a rating, the user, or the group of users. In some embodiments, social networking influences the shopping, shipping, selling and tracking behavior of the direct sale. In other embodiments, social networking influences the selection of the manufacturer, the different shipping provider, the product, the shipping service, the user, or the group of users in the direct sale. In some embodiments, the social networking comprises sending or allowing a request to or from the user or the group, communicating with the user or the group, or the like. In further embodiments, the request is for joining the group, accessing a profile of the user, communicating with the user or group, or the like. In further embodiments, the communication is a posting, a text message, a graphic message, a voice message, an email, an online chat, or the like.

In another aspect, disclosed herein are non-transitory computer-readable storage media encoded with a computer program including instructions executable by a processor to create an application comprising: a software module for creating and managing a profile, the profile comprising a user type, the user types comprising at least one production user type and at least one freight user type; a software module for connecting profiles to form a network; for a production user, a software module for generating a barcode, the barcode comprising a barcode type and a software module for generating a shipping request for a particular shipment, the request directed to an in-network freight user or to a bidding module where no in-network freight user exists; for a freight user, a software module for receiving a shipping request for a particular shipment from an in-network production user and a software module for bidding on shipping requests from an out-of-network production user; and a software module for rating user services. In some embodiments, the at least one freight user type is selected from: freight forwarder and freight transporter. In some embodiments, the at least one production user type is selected from: manufacturer and supplier. In some embodiments, the profiles are connected by an invitation and response process. In some embodiments, the platform is extensible offering user-selectable inclusion of one or more of: a production module, an accounting module, a fulfillment module, a sales module, and an e-marketing module, for a production user. In some embodiments, the platform is extensible offering user-selectable inclusion of one or more of: an accounting module, a route preparation module, a sales module, and an e-marketing module, for a freight user. In further embodiments, the route preparation module incorporates the knowledge of individual drivers of particular areas or routes. In further embodiments, the route preparation module incorporates individual parcel information to prepare vehicle loading guidance. In some embodiments, the barcode type is selected from: a production barcode, a parcel barcode, and a shipping barcode. In further embodiments, the barcode type is a shipping barcode and the barcode includes shipping information comprising one or more of: origin information, destination information, inventory information, tax information, insurance information, and customs information. In various embodiments, the barcode is a linear barcode, a two-dimensional barcode, or a high capacity color barcode. In some embodiments, the software module for bidding on shipping requests allows a user to bid on a portion of the shipping request. In some embodiments, the software module for rating user services allows rating other users with membership in a common network. In some embodiments, the rating comprises at least one comment. In some embodiments, the rating is on a five star scale. In some embodiments, for the freight user, the application further comprises a software module for generating a barcode, the barcode comprising a barcode type. In some embodiments, the application further comprises a software module for searching profiles. In some embodiments, the application further comprises a software module for advertising third-party goods and services.

In another aspect, described herein are non-transitory computer-readable storage media encoded with a computer program including instructions executable by a processor to create a member application comprising: a software module for a member or a group of members to sell or purchase a product; a software module for shipping the product, provided that the member or the group of members has the option to purchase a shipping service from at least two shipping providers; and a software module for tracking the product; and a software module for social networking. In some embodiments, the group comprises one or more members of the social network. In certain embodiments, the processor configured to provide the member application further comprises a software module for creating or managing a profile of the member. In further embodiments, the profile comprises a name, an address, a phone number, an email, a website, or a description of the member. In some embodiments, social networking influences the shopping, shipping, selling and tracking behavior of the direct sale. In other embodiments, social networking influences the selection of the manufacturer, the shipping provider, the product, the shipping service, the different member, or the different group of members in the direct sale. In certain embodiments, the processor configured to provide the member application further comprises a software module for creating the group. In further embodiments, the group is open to join or needs a permission to join. In further embodiments, the permission is granted by the member. In certain embodiments, the processor configured to provide the member application further comprises a software module for sending or allowing a request to or from the group or the member. In further embodiments, the request is for joining the group, accessing a profile of the member, communicating with the member, or the like. In some embodiments, the communication is a posting, a text message, a graphic message, a voice message, an email, an online chat, or the like. In certain embodiments, the processor configured to provide the member application further comprises a software module for presenting a catalog of the product. In further embodiments, the catalog comprises a name, a number, a description, or a price of the product. In further embodiments, the number is a catalog number, a series number, a barcode, or the like. In further embodiments, the description comprises a written, graphic, audio, or video description. In further embodiments, the description comprises a name, a dimension, a weight, a feature, a price, an expiration date, or a user manual. In some embodiments, the processor configured to provide the member application further comprises a software module for searching. In further embodiments, the searching comprises searching a database of the platform or a third-party. In further embodiments, the searching is for the product, a catalog, a rating, the user, or the group of users. In further embodiments, the catalog comprises a name, a number, a description, or a price of the product. In further embodiments, the number is a catalog number, a series number, a barcode, or the like. In further embodiments, the description comprises a written, graphic, audio, or video description. In further embodiments, the description comprises a name, a dimension, a weight, a feature, a price, an expiration date, or a user manual. In further embodiments, the rating is of the product, the catalog, the user, or the group of users. In further embodiments, the rating comprises a score, a review, a survey, a multiple-choice selection, a single-choice selection, or the like. In certain embodiments, the processor configured to provide the member application further comprises a software module for comparing prices of the product. In further embodiments, the prices comprise merchandise cost, taxes, shipping cost, or additional charges. In certain embodiments, the processor configured to provide the member application further comprises a software module for viewing or adding a rating of the product, a catalog, the member, or the group of members. In further embodiments, the rating comprises a score, a review, a survey, a multiple-choice selection, a single-choice selection, or the like. In certain embodiments, the processor configured to provide the member application further comprises a software module for placing an order. In certain embodiments, the processor configured to provide the member application further comprises a software module for sending or receiving a shipping request. In further embodiments, the shipping request comprises the recipient name, delivery address, delivery time, and shipping cost. In further embodiments, the shipping request further comprises a shipping route. In certain embodiments, the tracking is via a barcode. In further embodiments, the barcode is unique to an order. In certain embodiments, the processor configured to provide the member application further comprises a software module for requesting customer service. In further embodiments, the request is real-time. In further embodiments, the customer service comprises an inquiry, maintenance, a repair, an exchange, a replacement, a return, a refund, or the like. In certain embodiments, the processor configured to provide the member application further comprises a software module for generating a data analytic. In further embodiments, the data analytics comprises statistical, mathematical, logistic, logical, empirical analysis, or the like. In further embodiments, the data analytic is for the product, a catalog, a rating, the member, a profile of the member, or the group of members. In further embodiments, the rating is of the product, a catalog, the member, or the group of members. In certain embodiments, the processor configured to provide the member application further comprises a software module for managing a resource. In further embodiments, the resource comprises money, a raw material, or an employee. In certain embodiments, the processor configured to provide the member application further comprises a software module for creating and implementing a business plan. In further embodiments, the business plan is a marketing campaign. In further embodiments, the marketing campaign comprises a promotion, a free trial, an advertisement, a gift with purchase, a rebate, a referral, or the like.

In another aspect, described herein are non-transitory computer-readable storage media encoded with a computer program including instructions executable by a processor to create an administrator application comprising: a software module for creating or managing a database; and a software module for social networking. In some embodiments, the administrator is a person, a group of people, or a company that uses the social network. In some embodiments, the database is of a product, a catalog, a profile, a rating, a user, or a group of users. In further embodiments, the product is a piece of merchandise, service, or the like. In further embodiments, the catalog comprises a name, a number, a description, or a price of the product. In further embodiments, the profile comprises a name, an address, a phone number, an email, a website, or a description of the user. In further embodiments, the rating is of the product, a catalog, the user, or the group of users. In further embodiments, the rating comprises a score, a review, a survey, a multiple-choice selection, a single-choice selection, or the like. In further embodiments, the user is a person, a group of people, or a company that uses the social network. In further embodiments, the group comprises one or more users of the social network. In some embodiments, the processor configured to provide an administrator application further comprises a software module for categorizing a product into a category. In some embodiments, the processor configured to provide an administrator application further comprises a software module for generating a data analytic. In further embodiments, the data analytic is for a product, a catalog, a profile, a rating, a user, a profile of a user, or a group of users. In further embodiments, the data analytics comprises statistical, mathematical, logistic, logical, empirical analysis, or the like. In certain embodiments, the social networking comprises sending or allowing a request to or from the user or the group, communicating with the user or the group, or the like. In further embodiments, the request is for joining the group, accessing a profile of the user, communicating with the user or group, or the like. In further embodiments, the communication is a posting, a text message, a graphic message, a voice message, an email, an online chat, or the like.

In another aspect, disclosed herein are computer-implemented systems comprising: a digital processing device comprising an operating system configured to perform executable instructions and a memory device; a computer program including instructions executable by the digital processing device to create an application comprising: a software module for creating and managing a profile, the profile comprising a user type, the user types comprising at least one production user type and at least one freight user type; a software module for connecting profiles to form a network; for a production user, a software module for generating a barcode, the barcode comprising a barcode type and a software module for generating a shipping request for a particular shipment, the request directed to an in-network freight user or to a bidding module where no in-network freight user exists; for a freight user, a software module for receiving a shipping request for a particular shipment from an in-network production user and a software module for bidding on shipping requests from an out-of-network production user; and a software module for rating user services. In some embodiments, the at least one freight user type is selected from: freight forwarder and freight transporter. In some embodiments, the at least one production user type is selected from: manufacturer and supplier. In some embodiments, the profiles are connected by an invitation and response process. In some embodiments, the platform is extensible offering user-selectable inclusion of one or more of: a production module, an accounting module, a fulfillment module, a sales module, and an e-marketing module, for a production user. In some embodiments, the platform is extensible offering user-selectable inclusion of one or more of: an accounting module, a route preparation module, a sales module, and an e-marketing module, for a freight user. In further embodiments, the route preparation module incorporates the knowledge of individual drivers of particular areas or routes. In further embodiments, the route preparation module incorporates individual parcel information to prepare vehicle loading guidance. In some embodiments, the barcode type is selected from: a production barcode, a parcel barcode, and a shipping barcode. In further embodiments, the barcode type is a shipping barcode and the barcode includes shipping information comprising one or more of: origin information, destination information, inventory information, tax information, insurance information, and customs information. In various embodiments, the barcode is a linear barcode, a two-dimensional barcode, or a high capacity color barcode. In some embodiments, the software module for bidding on shipping requests allows a user to bid on a portion of the shipping request. In some embodiments, the software module for rating user services allows rating other users with membership in a common network. In some embodiments, the rating comprises at least one comment. In some embodiments, the rating is on a five star scale. In some embodiments, for the freight user, the application further comprises a software module for generating a barcode, the barcode comprising a barcode type. In some embodiments, the application further comprises a software module for searching profiles. In some embodiments, the application further comprises a software module for advertising third-party goods and services.

### BRIEF DESCRIPTION OF THE DRAWINGS

FIG. 1 shows a non-limiting example of a process flow; in this case, a process flow illustrating an exemplary uses of the platforms, systems, media, and methods described herein in manufacturing, production, and shipping.

FIG. 2 shows a non-limiting example of a schematic diagram; in this case, a schematic diagram illustrating the modular architecture of the platforms, systems, media, and methods described herein including the integration of both web and mobile applications.

FIG. 3 shows a non- non-limiting exemplary schematic diagram; in this case, a schematic diagram illustrating the platforms, systems, media, and methods described herein including a member application.

FIG. 4 shows a non-limiting exemplary schematic diagram; in this case, a schematic diagram illustrating the architecture of the platforms, systems, media, and methods described herein including the integration of a manufacturer, shipping provider, and consumer applications.

FIG. 5 shows a non-limiting exemplary schematic diagram; in this case, a schematic diagram illustrating the platforms, systems, media, and methods described herein including a consumer application.

### DETAILED DESCRIPTION OF THE INVENTION

Existing online shopping websites are unable to provide direct sale of products from manufacturers to consumers. With the current available online shopping services, a customer has to purchase a product from a distributor or retailer with additional invisible or indirect charges from the distributor, retailer, or the online websites. Furthermore, the customer has to spend extra time waiting for the order to arrive as the merchandise needs to be transported first from a manufacturer to the distributor or retailer. Another disadvantage associated with buying from a distributor or retailer is that it is not convenient to obtain post-sale services, if there is any at all. Additionally, existing online shopping websites are unable to offer direct and efficient communication between different stakeholders of the shopping network, i.e. manufacturer, shipping provider, and consumer, which needs to be achieved with separate social networking websites.

One advantage of the direct sale and social networking platform described herein is to enable direct sale of merchandises from a manufacturer to a customer. Other advantages of the platform described herein are elimination of invisible or indirect costs and shortening of merchandise transportation time. As a result, customers can shop for online merchandise with reduced total cost and faster delivery. Additional, the platform described herein allows the manufacturer to make more revenue by removing the charges associated with the service of a distributor or retailer. The manufacturer also gains direct interaction with customers for acquiring feedback; while the customers gain direct connection with manufacturers for possible post-sale services. Furthermore, the described direct sale and social networking platforms, systems, devices, media, and methods described herein also enable multiple stakeholders of the online shopping system to communication directly and efficiently which may in return facilitate the effective functioning of the online shopping platform.

Described herein, in certain embodiments, are computer-implemented platforms, systems, or devices for a direct sale to a user or a group of users comprising a processor configured to provide a consumer application comprising: a software module for the user or the group of users to purchase a product directly from a manufacturer of the product, provided that the user or the group of users has the option to purchase the product from at least two manufacturers; a software module for selecting a shipping service from a shipping provider for the product, provided that shipping is from the manufacturer to the user or the group of users, and provided that the user or the group of users has the option to purchase the shipping service from at least two shipping providers; a software module for tracking the product through the manufacturing and shipping processes; and a software module for social networking, provided that social networking comprises directly connecting to the manufacturer, the shipping provider, a different user, or a different group of users.

Also described herein, in various embodiments, are computer-implemented methods of a direct sale to a user or a group of users that comprises: providing, by a computer, an interface for purchasing a product directly from a manufacturer, provided that the user or the group of users has the option to purchase the product from at least two manufacturers; providing, by the computer, an interface for selecting a shipping service from a shipping provider for the product, provided that the shipping is from the manufacturer to the user or the group of users, and provided that the user or the group of users has the option to purchase a shipping service from at least two shipping providers; providing, by the computer, an interface for tracking the product through the manufacturing and shipping processes; and providing, by the computer, an interface for accessing a social network, provided that social networking comprises directly connecting to the manufacturer, the shipping provider, a different user, or a different group of users.

Also described herein, in various embodiments, are non-transitory computer-readable storage media encoded with a computer program including instructions executable by a processor to create a consumer application comprising: a software module for the user or the group of users to purchase a product directly from a manufacturer of the product, provided that the user or the group of users has the option to purchase the product from at least two manufacturers; a software module for selecting a shipping service from a shipping provider for the product, provided that shipping is from the manufacturer to the user or the group of users, and provided that the user or the group of users has the option to purchase the shipping service from at least two shipping providers; a software module for tracking the product through the manufacturing and shipping processes; and a software module for social networking, provided that social networking comprises directly connecting to the manufacturer, the shipping provider, a different user, or a different group of users.

Also described herein, in certain embodiments, are computer-implemented platform, system, or device for a direct sale to a user comprising a processor configured to provide a manufacturer application comprising: a software module for the manufacturer to directly sell a product to a user or a group of users; a software module for shipping the product, provided that shipping is from the manufacturer to the user or the group of users, and provided that the user or the group of users has the option to purchase a shipping service from at least two shipping providers; a software module for tracking the product through the manufacturing and shipping processes; and a software module for social networking, provided that social networking comprises directly connecting to a different manufacturer, the shipping provider, the user, or the group of users.

Also described herein, in certain embodiments, are computer-implemented methods of a direct sale of a product from a manufacturer to a user or a group of users that comprises: providing, by a computer, an interface for selling a product directly from the manufacturer to a user or a group of users, provided that the user or the group of users has the option to purchase the product from at least two manufacturers; and providing, by the computer, an interface for shipping the product; provided that shipping is from the manufacturer to the user or the group of users, and provided that the user or the group of users has the option to purchase a shipping service from at least two shipping providers; and providing, by the computer, an interface for tracking the product through the manufacturing and shipping processes; and providing, by the computer, an interface for accessing a social network, provided that social networking comprises directly connecting to a different manufacturer, the shipping provider, the user, or the group of users.

Also described herein, in certain embodiments, are non-transitory computer-readable storage media encoded with a computer program including instructions executable by a processor to create a manufacturer application comprising: a software module for the manufacturer to directly sell a product to a user or a group of users; a software module for shipping the product, provided that shipping is from the manufacturer to the user or the group of users, and provided that the user or the group of users has the option to purchase a shipping service from at least two shipping providers; a software module for tracking the product through the manufacturing and shipping processes; and a software module for social networking, provided that social networking comprises directly connecting to a different manufacturer, the shipping provider, the user, or the group of users.

Also described herein, in certain embodiments, are computer-implemented platforms, systems, or devices for a direct sale to a user or a group of users comprising a processor configured to provide a shipping provider application comprising: a software module for shipping a product from a manufacturer to the user or the group of users, provided that the user or the group of users has the option to purchase a shipping service from at least two shipping providers; and a software module for tracking the product through the manufacturing and shipping processes; and a software module for social networking, provided that social networking comprises directly connecting to the manufacturer, a different shipping provider, the user, or the group of users.

Also described herein, in some embodiments, are non-transitory computer-readable storage media encoded with a computer program including instructions executable by a processor to create a shipping provider application comprising: a software module for shipping a product from a manufacturer to the user or the group of users, provided that the user or the group of users has the option to purchase a shipping service from at least two shipping providers; and a software module for tracking the product through the manufacturing and shipping processes; and a software module for social networking, provided that social networking comprises directly connecting to the manufacturer, a different shipping provider, the user, or the group of users.

Also described herein, in certain embodiments, are direct shipping platforms comprising: a server processor configured to provide a web application for a production user or a freight user comprising: a software module for presenting a user interface, the user interface providing access to: a software module for creating and managing a profile, the profile comprising a user type, the user types comprising at least one production user type and at least one freight user type, a software module for connecting profiles to form a network, and a software module for rating user services.

Also described herein, in certain embodiments, are direct shipping platforms comprising: a server processor configured to provide an application for a production user or a freight user comprising: a software module for presenting a user interface, the user interface providing access to: a software module for creating and managing a profile, the profile comprising a user type, the user types comprising at least one production user type and at least one freight user type, a software module for connecting profiles to form a network, and a software module for rating user services; for the production user, a software module for generating a barcode, the barcode comprising a barcode type and a software module for generating a shipping request for a particular shipment, the request directed to an in-network freight user or to a bidding module where no in-network freight user exists; and for the freight user, a software module for receiving a shipping request for a particular shipment from an in-network production user and a software module for bidding on shipping requests from an out-of-network production user; at least one mobile processor configured to provide a mobile application for the freight user, the application comprising: a software module for reading a barcode and accessing shipping information contained therein; and a software module for capturing a signature in association with fulfillment of a shipping request.

Also described herein, in certain embodiments, are computer-implemented methods comprising: creating, by a computer, a profile, the profile having a production user type; connecting, by the computer, the profile with at least one other profile to create a network; where the network includes a user with a freight user type, generating, by the computer, a shipping request for a particular shipment, the request directed to an in-network freight user based on membership in a network and an operating area defined in the freight profile; where the network does not include a user with a freight user type, generating, by the computer, a shipping request for a particular shipment, the request directed to a bidding module and receiving, by the computer, bids on the shipping request; generating, by the computer, a shipping barcode and at least one parcel barcode, the barcodes comprising shipping information for the particular shipment; and rating, by the computer, services provided by the freight user.

Also described herein, in certain embodiments, are non-transitory computer-readable storage media encoded with a computer program including instructions executable by a processor to create an application comprising: a software module for creating and managing a profile, the profile comprising a user type, the user types comprising at least one production user type and at least one freight user type; a software module for connecting profiles to form a network; for a production user, a software module for generating a barcode, the barcode comprising a barcode type and a software module for generating a shipping request for a particular shipment, the request directed to an in-network freight user or to a bidding module where no in-network freight user exists; for a freight user, a software module for receiving a shipping request for a particular shipment from an in-network production user and a software module for bidding on shipping requests from an out-of-network production user; and a software module for rating user services.

Also described herein, in certain embodiments, are computer-implemented systems comprising: a digital processing device comprising an operating system configured to perform executable instructions and a memory device; a computer program including instructions executable by the digital processing device to create an application comprising: a software module for creating and managing a profile, the profile comprising a user type, the user types comprising at least one production user type and at least one freight user type; a software module for connecting profiles to form a network; for a production user, a software module for generating a barcode, the barcode comprising a barcode type and a software module for generating a shipping request for a particular shipment, the request directed to an in-network freight user or to a bidding module where no in-network freight user exists; for a freight user, a software module for receiving a shipping request for a particular shipment from an in-network production user and a software module for bidding on shipping requests from an out-of-network production user; and a software module for rating user services.

Also described herein, in certain embodiments, are computer-implemented platforms, systems, or devices for social networking comprising a processor configured to provide a member application comprising: a software module for a member or a group of members to directly sale or purchase product; a software module for shipping the product, provided that the member or the group of members has the option to purchase a shipping service from at least two shipping providers; and a software module for tracking the product through manufacture ring and shipping processes; and a software module for social networking, provided that social networking comprises directly connecting to the manufacturer, the shipping provider, a different member, or a different group of members.

Also described herein, in certain embodiments, are non-transitory computer-readable storage media encoded with a computer program including instructions executable by a processor to create a member application comprising: a software module for a member or a group of members to directly sale or purchase product; a software module for shipping the product, provided that the member or the group of members has the option to purchase a shipping service from at least two shipping providers; and a software module for tracking the product through manufacturing and shipping processes; and a software module for social networking, provided that social networking comprises directly connecting to the manufacturer, the shipping provider, a different member, or a different group of members.

### Certain Terminologies

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Consumer Applications

In some embodiments, the platforms, systems, devices, methods, and media described herein include a consumer application. In further embodiments, the consumer application is adapted for use by consumer users. In further applications, the consumer application includes tools and elements to enable consumer users to purchase products from a manufacturer or a shipping provider.

In some embodiments, a consumer application includes a software module for the user or the group of users to purchase a product directly from a manufacturer, provided that the user or the group of users has the option to purchase the product from at least two manufacturers. In some embodiments, a consumer is a person, a group of people, or a company that uses a social network. In some embodiments, a consumer is a person, a group of people, or a company that uses a direct sale platform. In further embodiments, the consumer is a person, a group of people, or a company that purchases manufactured good or service. In some embodiments, the consumer is the user or the group of users. In further embodiments, the product is a piece of merchandise, service, an animal, a natural article or the like that is legitimate to sell. In further embodiments, the direct sale is from the manufacturer without the participation of a distributor or a retailer. In further embodiments, the user is a person, a company, an organization, a community, a university, a farm, a church, a society, an association, an army, a firm, a team, a club, or the like. In some embodiments, the user comprises a single entity that accesses a direct sale platform or a social network. In some embodiments, a group comprises one or more users of a direct sale platform. In some embodiments, a group comprises one or more users of a social network.

In some embodiments, a consumer application includes a software module for creating or managing a profile. In some embodiments, a profile comprises public or private information of the user. In further embodiments, a profile includes, by way of non-limiting examples, a name, birthday, height, weight, gender, age, race, job, education, professional activity, award, certificate, blood type, astrology sign, address, phone number, email, fax, website, photos, hobby, description of self, resume, online activity, company history, company mission, event, blog, physical store locator, web link, online help, or the like.

In some embodiments, a consumer application includes a software module for searching. In some embodiments, searching comprises searching a database of the direct sale platform or a third-party. In some embodiments, searching comprises searching using a third-party search engine or a third-party website. In some embodiments, the searching comprises searching by google, Bing, yahoo, msn, baidu, YouTube, MapQuest, Yelp, eBay, Walmart, Target, Costco, Samsclub, CVS, Walgreen, Alibaba, Facebook, LinkedIn, Glassdoor, Twitter, Amazon, Gilt, Groupon, Livingsocial, JingDong, Tmall, Taobao, 58, Blekko, Duckduckgo, exalead, gigablast, munax, qwant, sogou, soso, yandex, youdao, kelkoo, pricegrabber, pronto, shopping, shopWiki, shopzilla, thefind, mysimon, pricerunner, or combinations of the same. In further embodiments, the searching is for a manufacturer, a shipping provider, a consumer, a product, a catalog, a profile, a rating, a user, or a group of users. In some embodiments, the searching comprises search terms using a generic name, a brand name, a phrase, a question, a picture, a photo, a sound track, a category name, a manufacturer name, a description, or combinations of the like. In some embodiments, the catalog comprises one or more products. In further embodiments, the catalog comprises a name, a price, a catalog number, a series number, a barcode, a photo, a dimension, a color, a size, a composition material, a weight, a function, an expiration date, a feature, a user manual, a written, a graphic, an audio, or a video description of the product. In some embodiments, the searching comprises searching with user-defined preferences. In further embodiments, the preferences includes the social networking status, business type, years of business, warranty, customer service policy, return policy, inventory, customization, rating, business location, product properties, product availability, payment types, currency, customs options, taxes, or the like.

In some embodiments, a consumer application includes a software module for viewing or adding a rating of a manufacturer, a shipping provider, a consumer, a product, a catalog, a user, or a group of users. In some embodiments, a rating comprises a score, a review, a survey, a multiple-choice selection, a single-choice selection, a star selection, or the like.

In some embodiments, a consumer application includes a software module for comparing price of the product. In further embodiments, each price comprises cost of the product, shipping, insurance, cost of extended warranty, cost of standard warranty, customs tax, cost of installation, cost of restocking, tax, or additional legitimate charges. In some embodiments, the price compared are from the manufacturer and shipping provider of the platform or of a third-party, a distributor, a retailer, an online store of a third-party, or combinations of the same. In further embodiments, the prices compared are retrieved by a platform provided searching tool or a third party search engine or website. In further embodiments, the third party search engine or website includes Google, Bing, yahoo, MSN, baidu, YouTube, MapQuest, yelp, eBay, Walmart, Target, Costco, Amazon, Groupon, gilt, living social, CVS, Walgreens, alibaba, Facebook, LinkedIn, glassdoor, twitter, JingDong, Tmall, Taobao, 58, Blekko, Duckduckgo, exalead, gigablast, munax, qwant, sogou, soso, yandex, youdao, kelkoo, pricegrabber, pronto, shopping, shopWiki, shopzilla, thefind, mysimon, pricerunner, or the like including combinations of the same.

In some embodiments, a consumer application includes a software module for placing an order. In some embodiments, the order is sent to a manufacturer user or a shipping provider user of a direct sale platform or a social network. In some embodiments, an order is sent real-time. In some embodiments, an order is sent with product information, billing information, or delivery information. In further embodiments, the billing information comprises information of a credit card, debit card, gift card, merchandise card, PayPal account, electronic check, smart card, electronic purse, or the like.

In some embodiments, a consumer application includes a software module for selecting a shipping service from a shipping provider for the product, provided that shipping is from the manufacturer to the user or the group of users, and provided that the user or the group of users has the option to purchase the shipping service from at least two shipping providers. In some embodiments, the shipping information and optional order information is sent to a bidding system. In some embodiment, the bidding module is provided by the direct sale platform or the social network. In other embodiments, the bidding system is provided by a third-party. In other embodiments, the shipping information is sent to more than two shipping providers based on service rating, shipping provider location, manufacturer's preference, customer's preference, insurance policy, international service types, domestic service types, requirement for shipping and handling of the order, social network connections, social network status, or combinations of the like. In some embodiments, the shipping information and the optional order information is sent out in real-time. In some embodiments, a consumer application includes a software module for sending a shipping request. In some embodiments, the shipping request is sent by the manufacturer, the user, or the group of users. In further embodiments, the shipping request is sent to a manufacturer, a shipping provider, a freight user, or a transportation provider which comprises UPS, FedEx, USPS, DHL, greyhound, mega bus, Amtrak, an airline, a shuttle company, a taxi company, a sea transport company, or the like. In some embodiments, the shipping request is sent out in real-time. In some embodiments, a shipping request comprise an origin, a sender name, a recipient name, a delivery address, a delivery time, shipping content, shipping weight, shipping costs, insurance value, insurance cost, shipping instructions, customs options, and shipping route. In some embodiments, a shipping route can be determined by the preference of a consumer, real-time traffic, shipping distance, road condition, road speed limit, weather, vehicle type, Google map, MapQuest, GPS, Yahoo map, or the like. In other embodiments, the consumer application includes a software module for posting the shipping request for bidding.

In some embodiments, a consumer application includes a software module for tracking the product through the manufacturing and shipping processes. In some embodiments, a consumer application includes a software module for tracking an order through the manufacturing and shipping processes. In some embodiments, the tracking is enabled when the product is being manufactured. In some embodiments, the tracking includes tracking when the product is transported from the manufacturer to the shipping provider. In some embodiments, the tracking status is updated real-time. In further embodiments, the tracking is via the barcode that is unique to the order. In some embodiments, a barcode can be one, two, or three dimensional barcode. In some embodiments, the barcode can be scanned or typed into digital devices. In some embodiments, a barcode is generated by the direct sale platform. In some embodiments, tracking information is obtained from the shipping provider, the manufacturer, the direct sale platform, the user, or the group of users. In some embodiments, tracking information is obtained from a website, a webpage, an email, a text message, a voice message, a phone call, a web link, a mobile application, or the like.

In some embodiments, a consumer application includes a software module for sending a request for customer service. In some embodiments, a request is sent in real-time. In further embodiments, the customer service comprises an inquiry, maintenance, a repair, an exchange, a replacement, a return, a refund, a recall, a warranty service, a trial, a sample, a question, or the like.

In some embodiments, a consumer application further includes a software module for managing and analyzing data, provided that data are related to the direct sale. In further embodiments, data includes a payment, an invoice, a shipping request, a shipping quote, a customer service request, a price, a product or a service, a barcode, tracking record, an order information, a delivery time, or the like. In some embodiments, a consumer application includes a software module for viewing a data analytic. In further embodiments, the data analytic comprises statistical, mathematical, logistic, logical, economical, computational, empirical, logic, logistic, quantitative, qualitative analysis, or the like. In some embodiments, a data analytic is for a manufacturer, a shipping provider, a consumer, a product, a catalog, a rating, a user, the profile of a user, a group, or combinations of the same. In some embodiments, a data analytic is generated based on data of a hour, a number of hours, day, a number of days, week, a number of weeks, month, several months, quarter, year, two years, three years, four years, five years, six years, seven year, eight years, nine years, or ten years. In some embodiments, a rating com comprises a score, a review, a survey, a multiple-choice selection, a single-choice selection, a star selection, or the like.

In some embodiments, a consumer application includes a software module for creating a group of users. In further embodiments, the group has one or more users of the direct sale platform. In some embodiments, a group comprises one or more users of a social network. In some embodiments, the group is public or private. In some embodiments, the group is open or needs a permission to join. In some embodiments, information is visible only to the users that joined a group of users.

In some embodiments, a consumer application includes a software module for social networking, provided that social networking comprises directly connecting to the manufacturer, the shipping provider, a different user, or a different group of users. In some embodiments, social networking influences the shopping, shipping, selling and tracking behavior of the direct sale. In other embodiments, social networking influences the selection of a manufacturer, a shipping provider, a product, a shipping service, a user, or a group of users in a direct sale. In some embodiments, the social networking influences the searching preferences. In some embodiments, social networking comprises sending or allowing a request to or from the user or the group, communicating with the user or a group, broadcasting to multiple users or groups, or the like. In further embodiments, the request is for joining the group, accessing the profile of the user, communicating with the user or a group, blocking the user or the group, tagging the user or the group of users. In further embodiments, the communication is a web posting, a text message, a graphic message, a voice message, a video message, a live online broadcasting of sound, image, video, or text, an online meeting, an online call, an email, an online chat, an online comment, a rating, a tag, a group conversation, a reposting or sharing, a citing, a following of a user or a group of user's online activities, or the like.

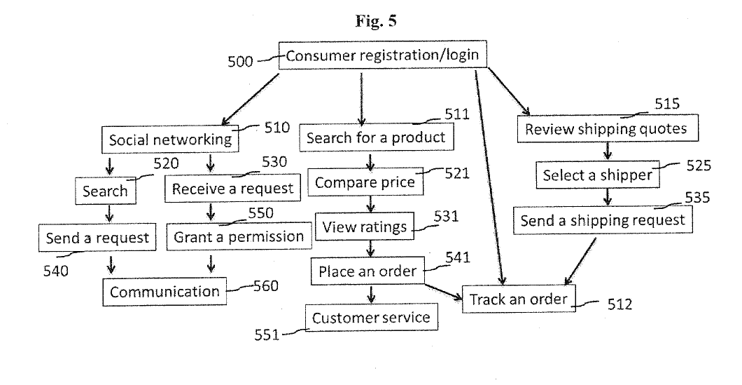

Referring to FIG. 5, in a particular embodiment, a consumer registers or logs in 500 to a direct sale and social network system. In this embodiments, the consumer searches 511 for a specific product of interests. Also in this embodiment, the consumer compares price 521 of the specific product by different manufacturers and views ratings 531 of the specific product and optionally the manufacturers. Afterward, the consumer optionally places an order with a selected manufacturer 541. Also in this particular embodiment, the consumer receives shipping quotes and reviews the quotes 515 for the order. Afterward, the consumer selects a shipper 525 and sends a shipping request 535 to the selected shipper. In the same embodiment, the consumer tracks the order 512 using a unique barcode. The product is being tracked from the manufacturer to the shipping, and then the consumer. Also in this embodiment, the consumer requests customer service 551 directly from the manufacturer when needed. In this embodiment, the consumer optionally accesses the social network 510 to search 520 for a user or a group of users and sends a request for communication with the user or the group of users 540. In the same embodiment, the consumer optionally receives a request 530 from another user or a group of users for communication. Also in this embodiment, the consumer grants permission 550 after receiving the request and starts communicating 560 with the user or the group of users who sends the request.

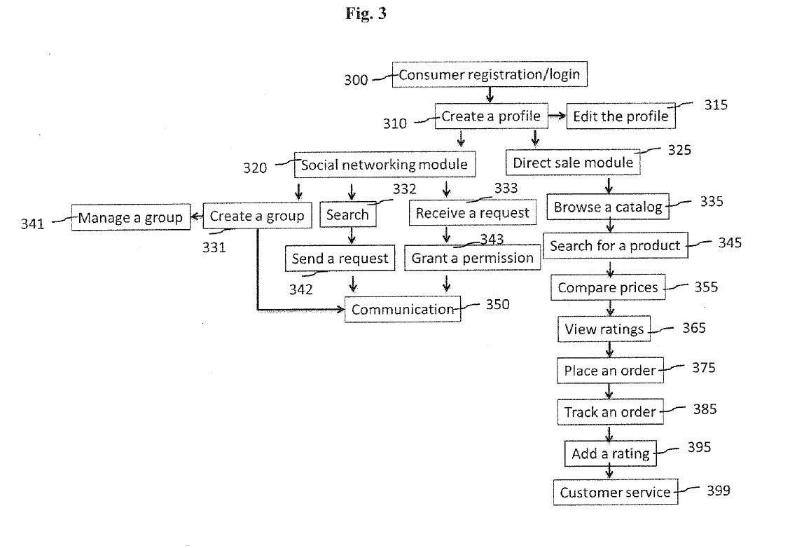

Referring to FIG. 3, in a particular embodiment, a consumer registers or logs in 300 on a direct sale and social networking platform. In this embodiment, the consumer creates a profile 310 and optionally edits the profile 315. In this embodiment, the consumer optionally accesses the social networking module 320 to create a group 331 or manage a group 341. In this embodiment, the consumer optionally searches 332 for a user or a group and sends a request 342 for communication. Also in this embodiment, the consumer optionally receives a request 333 for viewing or communicating with him or her. In this embodiment, the consumer grants permission 343 and starts communication 350 with one or more other users. Further in this embodiment, the consumer optionally accesses the direct sale module 325 to browse a catalog 335, if the consumer didn't find the product; he or she searches 345 for a specific product to buy. Also in this embodiment, the consumer compares prices 355 and views ratings 365 of the specific product of interests offered to sell by different manufacturers, and places an order 375. Further in this embodiment, the consumer tracks the order 385, adds a rating 395 of the manufacturer, product, or shipping provider. Also in this embodiment, the consumer request customer service 399 if needed directly from the manufacturer.

### Manufacturer Applications

In some embodiments, the platforms, systems, devices, methods, and media described herein include a manufacturer application. In further embodiments, the manufacturer application is adapted for use by manufacturer users. In further applications, the manufacturer application includes tools and elements to enable manufacture users to list, present, and sell products to consumers.

In some embodiments, the manufacturer application includes a software module for the manufacturer to directly sell a product to a user or a group of users. In some embodiments, at least one of the manufacturer, the user, or the group of users is a member of a social network.

In some embodiments, a manufacturer is a person, a group of people, or a company that manufactures products for sale. In some embodiments, a manufacturer is a person, a group of people, or a company that uses a social network. In some embodiments, a manufacturer is a person, a group of people, or a company that uses a direct sale platform. In further embodiments, the product is a piece of merchandise, service, an animal, a natural article or the like that is legitimate to sell. In some embodiments, a direct sale is from the manufacturer without the participation of an inter-mediator. In further embodiments, the inter-mediator includes, by way of non-limiting examples, a distributor, a retailer, a dealer, a middleperson, a trader, an agent, a mediator, an inter-agent, or a wholesaler, merchant, tradesperson, trafficker, or combinations of the same. In further embodiments, the user is a person, a company, an organization, a community, a university, a farm, a church, a society, an association, an army, a firm, a team, a club or the like that accesses the direct sale platform as a single entity. In further embodiments, the group comprises one or more users of the direct sale platform. In some embodiments, the group comprises one or more users of a social network.

In some embodiments, the manufacturer application includes a software module for creating or managing a profile. In some embodiments, a profile comprises public or private information of the user. In further embodiments, a profile includes, by way of non-limiting examples, a name, birthday, height, weight, gender, age, race, job, education, professional activity, award, certificate, blood type, astrology sign, address, phone number, email, fax, website, photos, hobby, description of self, resume, online activity, company history, company mission, event, blog, physical store locator, web link, online help, or the like.

In some embodiments, the manufacturer application includes a software module for creating a catalog. In further embodiments, the catalog comprises one or more products for sale. In some embodiments, a catalog comprises a name, a price, a catalog number, a series number, a barcode, a photo, a dimension, a color, a size, a composition material, a weight, a function, an expiration date, a feature, a user manual, a written, a graphic, an audio, or a video description of the product.

In some embodiments, the manufacturer application includes a software module for receiving an order. In some embodiments, the order is from a user or a group of users of a direct sale platform. In some embodiments, the order is from a user or a group of users of a social network. In some embodiments, an order is received real-time. In further embodiments, the order is received with product information, billing information, or delivery information. In further embodiments, the billing information comprises information of a credit card, debit card, gift card, merchandise card, PayPal account, electronic check, smart card, electronic purse, or the like.

In some embodiments, the manufacturer application includes a software module for shipping the product, provided that shipping is from the manufacturer to the user or the group of users, and provided that the user or the group of users has the option to purchase a shipping service from at least two shipping providers. In some embodiments, the shipping information and optional order information is sent to a bidding system. In some embodiment, the bidding module is provided by the direct sale platform or the social network. In other embodiments, the bidding system is provided by a third-party. In other embodiments, the shipping information is sent to more than two shipping providers based on service rating, shipping provider location, manufacturer's preference, customer's preference, insurance policy, international service types, domestic service types, requirement for shipping and handling of the order, or combinations of the like. In some embodiments, the shipping information and the optional order information is sent out in real-time. In some embodiments, the manufacturer application includes a software module for sending a shipping request. In some embodiments, the shipping request is sent to a shipping provider, a freight user, or a transportation provider which comprises UPS, FedEx, USPS, DHL, greyhound, mega bus, Amtrak, an airline, a shuttle company, a taxi company, a sea transport company, or the like. In some embodiments, a shipping request comprise an origin, a sender name, a recipient name, a delivery address, a delivery time, shipping content, shipping weight, shipping costs, insurance value, insurance cost, shipping instructions, customs options, and shipping route. In some embodiments, a shipping route can be determined by the preference of a consumer, real-time traffic, shipping distance, road condition, road speed limit, weather, vehicle type, Google map, MapQuest, GPS, Yahoo map, or the like.

In some embodiments, the manufacturer application includes a software module for tracking the product through the manufacturing and shipping processes. In some embodiments, tracking is via a barcode that is unique to an order. In some embodiments, a barcode is generated by the direct sale platform. In some embodiments, a barcode is one, two, or three dimensional barcode. In some embodiments, a barcode can be scanned or typed into digital devices. In some embodiments, a barcode is generated by the direct sale platform. In some embodiments, tracking includes tracking while the product is being manufactured. In some embodiments, tracking includes tracking while the product is shipped from the manufacturer to a shipping provider or from a shipping provider to a consumer. In some embodiments, tracking information is obtained from the shipping provider, the manufacturer, the direct sale platform, or the consumer. In some embodiments, tracking information is obtained from a website, a webpage, an email, a text message, a voice message, a phone call, a web link, a mobile application, or the like.

In some embodiments, the manufacturer application includes a software module for receiving a request for customer service. In some embodiments, a request is received in real-time. In further embodiments, the customer service comprises an inquiry, maintenance, a repair, an exchange, a replacement, a return, a refund, a recall, a warranty service, a trial, a sample, a question, or the like.

In some embodiments, the manufacturer application includes a software module for viewing a data analytic. In further embodiments, the data analytic comprises statistical, mathematical, logistic, logical, economical, computational, empirical, logic, logistic, quantitative, qualitative analysis, or the like. In some embodiments, a data analytic is for a manufacturer, a shipping provider, a consumer, a product, a catalog, a rating, a user, the profile of a user, a group, or combinations of the same. In some embodiments, a data analytic is generated based on data of a hour, a number of hours, day, a number of days, week, a number of weeks, month, several months, quarter, year, two years, three years, four years, five years, six years, seven year, eight years, nine years, or ten years. In some embodiments, a rating comprises a score, a review, a survey, a multiple-choice selection, a single-choice selection, a star selection, or the like.

In some embodiments, a manufacturer application includes a software module for managing a resource. In some embodiments, a resource comprises money, a stock, an IPO, a derivative, a raw material, an employee, a device, a location, software, an algorithm, a database, a document, or the like.

In some embodiments, a manufacturer application includes a software module for creating and implementing a business plan. In some embodiments, a business plan is a marketing campaign. In further embodiments, the marketing campaign comprises a promotion, a free trial, an advertisement, a gift with purchase, a rebate, a gift with referral, a free installation with purchase, a free service with purchase, a product rating with gift, free shipping with purchase, a free return with purchase, a raffle, or the like.

In some embodiments, a manufacturer application includes a software module for social networking, provided that social networking comprises directly connecting to a different manufacturer, the shipping provider, the user, or the group of users. In some embodiments, social networking influences the shopping, shipping, selling and tracking behavior of the direct sale. In other embodiments, social networking influences the selection of a manufacturer, a shipping provider, a product, a shipping service, a user, or a group of users in a direct sale.

In some embodiments, a manufacturer application includes a software module for creating a group of users. In further embodiments, the group has one or more users of the direct sale platform. In some embodiments, a group has one or more users of a social network. In some embodiments, the group is public or private. In some embodiments, the group is open or needs a permission to join. In some embodiments, permission is granted by a user. In some embodiments, information is visible only to the users that joined a group of users.

In some embodiments, a manufacturer application includes a software module for viewing or adding a rating of a manufacturer, a shipping provider, a consumer, a product, a catalog, a user, or a group of users. In some embodiments, a rating comprises a score, a review, a survey, a multiple-choice selection, a single-choice selection, a star selection, or the like.

In some embodiments, a manufacturer application includes a software module for searching. In some embodiments, searching comprises searching a database of a direct sale platform or a third-party. In some embodiments, searching comprises searching using a third-party search engine or a third-party website that includes google, Bing, yahoo, msn, baidu, youtube, MapQuest, yelp, eBay, Walmart, target, Costco, cvs, Walgreen, alibaba, Facebook, LinkedIn, Glassdoor, Twitter, Amazon, Gilt, Groupon, Livingsocial, JingDong, Tmall, Taobao, 58, Blekko, Duckduckgo, exalead, gigablast, munax, qwant, sogou, soso, yandex, youdao, kelkoo, pricegrabber, pronto, shopping, shopWiki, shopzilla, thefind, mysimon, pricerunner, or combinations of the same. In further embodiments, the searching is for a manufacturer, a shipping provider, a consumer, a product, a catalog, a profile, a rating, a user, or a group of users. In some embodiments, the searching comprises searching with user-defined preferences. In further embodiments, the preferences includes the social networking status, business type, years of business, warranty, customer service policy, return policy, inventory, customization, rating, business location, product properties, product availability, payment types, currency, customs options, taxes, or the like.

In some embodiments, a manufacturer application includes a software module for social networking. In some embodiments, the social networking comprises sending or allowing a request to or from a user or a group, communicating with a user or a group, broadcasting to multiple users or groups, or the like. In further embodiments, the request is for joining a group, accessing the profile of a user, communicating with a user or a group, blocking a user or a group, tagging a user or a group, or following a user or a group of users. In further embodiments, the communication is a web posting, a text message, a graphic message, a voice message, a video message, a live online broadcasting of sound, image, video, or text, an online meeting, an online call, an email, an online chat, an online comment, a rating, a tag, a group conversation, a reposting or sharing, a citing, a following of a user or a group of user's online activities, or the like.

### Shipping Provider Applications

In some embodiments, the platforms, systems, devices, methods, and media described herein include a shipping provider application. In further embodiments, the shipping provider application is adapted for use by shipping provider users. In further applications, the shipping provider application includes tools and elements to enable shipping provider users to list, present, sell and fulfill shipping service to consumers.

In some embodiments, a shipping provider application includes a software module for shipping a product to a user or a group of users. In some embodiments, a shipping provider is a person, a group of people, or a company that uses a social network. In some embodiments, a shipping provider is a person, a group of people, or a company that uses a direct sale platform. In some embodiments, a shipping provider is a person, a group of people, or a company that provides shipping, freight, or transportation service. In further embodiments, the shipping provider, by way of non-limiting examples, includes a transportation provider, a freight provider, UPS, FedEx, USPS, DHL, greyhound, mega bus, Amtrak, an airline, a taxi, a ship, a train, a bus, a shuttle, a sea transport company, a ferry, or the like. In some embodiments, the product is a piece of merchandise, service, an animal, a natural article or the like that is legitimate to sell. In some embodiments, the user is a person, a company, an organization, a community, a university, a farm, a church, a society, an association, an army, a firm, a team, a club or the like that accesses the direct sale platform as a single entity. In some embodiments, the group of users comprises one or more users of a direct sale platform. In some embodiments, the group of users comprises one or more users of a social network.

In some embodiments, a shipping provider application includes a software module for creating or managing a profile. In some embodiments, a profile comprises public or private information of a user. In further embodiments, a profile includes, by way of non-limiting examples, a name, birthday, height, weight, gender, age, race, job, education, professional activity, award, certificate, blood type, astrology sign, address, phone number, email, fax, website, photos, hobby, description of self, resume, online activity, company history, company mission, event, blog, physical store locator, web link, online help, or the like.

In some embodiments, a shipping application includes a software module for creating a catalog. In further embodiments, the catalog comprises one or more types of services. In some embodiments, a catalog comprises a name, a price, a catalog number, a series number, a function, a feature, a written, a graphic, an audio, or a video description of the service.

In some embodiments, a shipping provider application includes a software module for receiving a shipping request. In some embodiments, a shipping request comprise an origin, a sender name, a recipient name, a delivery address, a delivery time, shipping content, shipping weight, shipping costs, insurance value, insurance cost, shipping instruction, customs option, and shipping route. In some embodiments, a shipping route can be determined by the preference of a consumer, real-time traffic, shipping distance, road condition, road speed limit, weather, vehicle type, Google map, MapQuest, GPS, Yahoo map, or the like.

In some embodiments, a shipping provider application includes a software module for generating a shipping quote. In further embodiments, the shipping quote comprises costs determined by the product size, dimension, weight, shipping distance, type of shipping service, type of delivery, delivery confirmation, insurance cost, customs option, insurance value, tracking, selection of shipping route, tax, convenience charges, or the like.

In some embodiments, a shipping provider application includes a software module for outsourcing a shipping service to other users. In some embodiments, the shipping provider application includes a software module for allowing a customer to select a pick-up location. In other embodiments, the shipping provider application includes a software module for shipping route planning. In some embodiments, the route planning is automatically generated by the platform. In some embodiments, the route planning is based on delivery personnel's schedule, distance, toll, real-time traffic, route speed limit, road condition, ferry, or customer's preference. In some embodiments, a shipping route is optimized based on the total amount of time, distance, toll, traffic, speed limit, road condition to deliver multiple products.

In some embodiments, a shipping provider application includes a software module for generating a barcode. In some embodiments, tracking is via the barcode that is unique to a shipment. In some embodiments, a barcode is one, two, or three dimensional barcode. In some embodiments, a barcode can be scanned or typed into digital devices. In some embodiments, a barcode is generated by the direct sale platform. In some embodiments, a shipping provider application includes a software module for tracking the product through the manufacturing and shipping processes.

In some embodiments, a shipping provider application includes a software module for receiving a request for customer service. In some embodiments, a request is received in real-time.

In some embodiments, a shipping provider application includes a software module for viewing a data analytic. In further embodiments, the data analytic comprises statistical, mathematical, logistic, logical, economical, computational, empirical, logic, logistic, quantitative, qualitative analysis, or the like. In some embodiments, a data analytic is for a manufacturer, a shipping provider, a consumer, a product, a catalog, a rating, a user, the profile of a user, a group, or combinations of the same. In some embodiments, a data analytic is generated based on data of a hour, a number of hours, day, a number of days, week, a number of weeks, month, several months, quarter, year, two years, three years, four years, five years, six years, seven year, eight years, nine years, or ten years. In some embodiments, a rating comprises a score, a review, a survey, a multiple-choice selection, a single-choice selection, a star selection, or the like.

In some embodiments, a shipping provider application includes a software module for managing a resource. In some embodiments, a resource comprises money, a stock, an IPO, a derivative, a raw material, an employee, a device, a location, software, an algorithm, a database, a document, or the like.

In some embodiments, a shipping provider application includes a software module for creating and implementing a business plan. In some embodiments, a business plan is a marketing campaign. In further embodiments, the marketing campaign comprises a promotion, a free trial, an advertisement, a gift with purchase, a rebate, a gift with referral, a free unpacking with purchase, a free service with purchase, a rating with gift, free shipping, a free return service, a raffle, or the like.

In some embodiments, a shipping provider application includes a software module for creating a group of users. In further embodiments, the group has one or more users of a direct sale platform. In further embodiments, a group has one or more users of a social network. In some embodiments, the group is public or private. In some embodiments, the group is open or needs a permission to join. In some embodiments, information is visible only to the users that joined a group of users.

In some embodiments, a shipping provider application includes a software module for viewing or adding a rating of a manufacturer, a shipping provider, a consumer, a product, a catalog, a user, or a group of users. In some embodiments, a rating comprises a score, a review, a survey, a multiple-choice selection, a single-choice selection, a star selection, or the like.

In some embodiments, a shipping provider application includes a software module for searching. In some embodiments, searching comprises searching a database of the direct sale platform or a third-party. In some embodiments, searching comprises searching using a third-party search engine or a third-party website that includes google, Bing, yahoo, msn, baidu, youtube, MapQuest, yelp, eBay, Walmart, target, Costco, cvs, Walgreen, alibaba, Facebook, LinkedIn, glassdoor, twitter, amazon, gilt, group on, livingsocial, JingDong, Tmall, Taobao, 58, Blekko, Duckduckgo, exalead, gigablast, munax, qwant, sogou, soso, yandex, youdao, kelkoo, pricegrabber, pronto, shopping, shopWiki, shopzilla, thefind, mysimon, pricerunner, or combinations of the same. In further embodiments, the searching is for a manufacturer, a shipping provider, a consumer, a product, a catalog, a profile, a rating, a user, or a group of users. In some embodiments, the searching comprises searching with user-defined preferences. In further embodiments, the preferences includes the social networking status, business type, years of business, warranty, customer service policy, return policy, inventory, customization, rating, business location, product properties, product availability, payment types, currency, customs options, taxes, or the like.

In some embodiments, a shipping provider application includes a software module for social networking, provided that social networking comprises directly connecting to the manufacturer, a different shipping provider, the user, or the group of users. In some embodiments, social networking influences the shopping, shipping, selling and tracking behavior of the direct sale. In other embodiments, social networking influences the selection of a manufacturer, a shipping provider, a product, a shipping service, a user, or a group of users in a direct sale. In some embodiments, social networking comprises sending or allowing a request to or from the user or the group, communicating with the user or a group, broadcasting to multiple users or groups, or the like. In further embodiments, the request is for joining the group, accessing the profile of the user, communicating with the user or a group, blocking the user or the group, tagging the user or the group of users. In further embodiments, the communication is a web posting, a text message, a graphic message, a voice message, a video message, a live online broadcasting of sound, image, video, or text, an online meeting, an online call, an email, an online chat, an online comment, a rating, a tag, a group conversation, a reposting or sharing, a citing, a following of a user or a group of user's online activities, or the like.

### Member Applications

In some embodiments, the platforms, systems, devices, methods, and media described herein include a member application. In further embodiments, the member application is adapted for use by administrator users. In further applications, the member application includes tools and elements to enable member users to sell, purchase, or ship products.

In some embodiments, a member application includes a software module for a member or a group to directly sale or purchase a product. In some embodiments, a member is a person, a group of people, or a company that purchases or sells manufactured good, or provides service. In some embodiments, a member is a person, a company, an organization, a community, a university, a farm, a church, a society, an association, an army, a firm, a team, a club or the like that accesses the direct sale platform as a single entity. In some embodiments, a member is a person, a group of people, or a company that uses a social network. In some embodiments, the group comprises one or more members of a social network. In some embodiments, the group comprises one or more members of a direct sale platform. In further embodiments, a product is a piece of merchandise, service, an animal, a natural article or the like that is legitimate to sell. In some embodiments, a direct sale is from a manufacturer without the participation of a distributor or a retailer.

In some embodiments, a member application includes a software module for creating or managing a profile. In some embodiments, a profile comprises public or private information of the user. In further embodiments, a profile includes, by way of non-limiting examples, a name, birthday, height, weight, gender, age, race, job, education, professional activity, award, certificate, blood type, astrology sign, address, phone number, email, fax, website, photos, hobby, description of self, resume, online activity, company history, company mission, event, blog, physical store locator, web link, online help, or the like.

In some embodiments, a member application includes a software module for social networking, provided that social networking comprises directly connecting to the manufacturer, a different shipping provider, the user, or the group of users. In some embodiments, social networking influences the shopping, shipping, selling and tracking behavior of the direct sale. In other embodiments, social networking influences the selection of a manufacturer, a shipping provider, a product, a shipping service, a member, or a group of members in a direct sale.

In some embodiments, a member application includes a software module for creating a group of users. In some embodiments, a group has one or more member of a direct sale platform. In some embodiments, a group is public or private. In some embodiments, a group is open or needs a permission to join. In some embodiments, information is visible only to the users that joined a group of users.

In some embodiments, a member application includes a software module for social networking. In some embodiments, social networking comprises sending or allowing a request to or from a user or a group, communicating with a user or a group, broadcasting to multiple users or groups, or the like. In further embodiments, the request is for joining a group, accessing the profile of a user, communicating with a user or a group, blocking a user or a group, tagging a user or a group, or following a user or a group of users. In further embodiments, the communication is a web posting, a text message, a graphic message, a voice message, a video message, a live online broadcasting of sound, image, video, or text, an online meeting, an online call, an email, an online chat, an online comment, a rating, a tag, a group conversation, a reposting or sharing, a citing, a following of a user or a group of user's online activities, or the like.

In some embodiments, a member application includes a software module for searching. In some embodiments, searching comprises searching a database of the direct sale platform, of the social network, or a third-party. In some embodiments, searching comprises searching using a third-party search engine or a third-party website that includes google, Bing, yahoo, msn, baidu, youtube, MapQuest, yelp, eBay, Walmart, target, Costco, cvs, Walgreen, alibaba, Facebook, LinkedIn, glassdoor, twitter, amazon, gilt, Groupon, living social, or combinations of the same. In some embodiments, searching is for a manufacturer, a shipping provider, a consumer, a product, a catalog, a profile, a rating, a user, or a group of users. In some embodiments, the searching comprises searching with user-defined preferences. In further embodiments, the preferences includes the social networking status, business type, years of business, warranty, customer service policy, return policy, inventory, customization, rating, business location, product properties, product availability, payment types, currency, customs options, taxes, or the like.

In some embodiments, a member application includes a software module for creating a catalog. In some embodiments, a catalog comprises one or more products for sale. In some embodiments, a catalog comprises a name, a price, a catalog number, a series number, a barcode, a photo, a dimension, a color, a size, a composition material, a weight, a function, an expiration date, a feature, a user manual, a written, a graphic, an audio, or a video description of a product.

In some embodiments, a member application includes a software module for comparing prices of a product. In further embodiments, each price comprises cost of the product, shipping, insurance, cost of extended warranty, cost of standard warranty, cost of installation, cost of restocking, tax, or additional legitimate charges. In some embodiments, prices compared are from the manufacturer and shipping provider of the platform or of a third-party, a distributor, a retailer, an online store of a third-party, or combinations of the same. In some embodiments, the prices compared are retrieved by a platform provided searching tool or a third party search engine or website. In further embodiments, the third party search engine or website includes google, Bing, yahoo, msn, baidu, youtube, MapQuest, yelp, eBay, Walmart, target, Costco, Amazon, Groupon, gilt, living social, CVS, Walgreens, alibaba, Facebook, LinkedIn, glassdoor, twitter, or the like including combinations of the same.

In some embodiments, a member application includes a software module for viewing or adding a rating of a manufacturer, a shipping provider, a consumer, a product, a catalog, a user, or a group of users. In some embodiments, a rating comprises a score, a review, a survey, a multiple-choice selection, a single-choice selection, a star selection, or the like.

In some embodiments, a member application includes a software module for placing or receiving an order. In some embodiments, an order is placed or received by or from a user or a group of users. In some embodiments, an order is received real-time. In some embodiments, an order is received with product information, billing information, or delivery information. In further embodiments, the billing information comprises information of a credit card, debit card, gift card, merchandise card, PayPal account, electronic check, smart card, electronic purse, or the like.

In some embodiments, a member application includes a software module for sending or receiving a shipping request. In some embodiments, a shipping request is sent to a manufacturer, a shipping provider, a freight user, or a transportation provider which comprises UPS, FedEx, USPS, DHL, greyhound, mega bus, Amtrak, an airline, a shuttle company, a taxi company, a sea transport company, or the like. In some embodiments, a shipping request comprise an origin, a sender name, a recipient name, a delivery address, a delivery time, shipping content, shipping weight, shipping costs, insurance value, insurance cost, shipping instruction, customs options, and shipping route. In some embodiments, a shipping route can be determined by the preference of a consumer, real-time traffic, shipping distance, road condition, road speed limit, weather, vehicle type, Google map, MapQuest, GPS, Yahoo map, or the like. In other embodiments, the member application includes a software module for posting the shipping request for bidding.

In some embodiments, a member application includes a software module for generating a shipping quote. In further embodiments, the shipping quote comprises costs determined by the product size, dimension, weight, shipping distance, type of shipping service, type of delivery, delivery confirmation, insurance cost, insurance value, customs option, tracking, selection of shipping route, tax, convenience charges, or the like.

In some embodiments, a member application includes a software module for outsourcing a shipping service. In some embodiments, the member application includes a software module for allowing a customer to select a pick-up location. In other embodiments, the member application includes a software module for shipping route planning. In some embodiments, the route planning is automatically generated by the platform. In some embodiments, the route planning is based on delivery personnel's schedule, distance, toll, real-time traffic, route speed limit, road condition, ferry, or customer's preference. In some embodiments, a shipping route is optimized based on the total amount of time, distance, toll, traffic, speed limit, road condition to deliver multiple products.

In some embodiments, a member application includes a software module for tracking the product through the manufacturing and shipping processes. In some embodiments, tracking is via a barcode that is unique to the order. In some embodiments, the barcode can be one, two, or three dimensional barcode. In some embodiments, a barcode can be scanned or typed into digital devices. In some embodiments, a barcode is generated by the direct sale platform.

In some embodiments, a member application includes a software module for receiving a request for customer service. In some embodiments, a request is received in real-time. In further embodiments, customer service comprises an inquiry, maintenance, a repair, an exchange, a replacement, a return, a refund, a recall, a warranty service, a trial, a sample, a question, or the like.

In some embodiments, a member application includes a software module for viewing a data analytic. In further embodiments, the data analytic comprises statistical, mathematical, logistic, logical, economical, computational, empirical, logic, logistic, quantitative, qualitative analysis, or the like In some embodiments, a data analytic is for a manufacturer, a shipping provider, a consumer, a product, a catalog, a rating, a user, the profile of a user, a group, or combinations of the same. In some embodiments, a data analytic is generated based on data of a hour, a number of hours, day, a number of days, week, a number of weeks, month, several months, quarter, year, two years, three years, four years, five years, six years, seven year, eight years, nine years, or ten years. In some embodiments, a rating comprises a score, a review, a survey, a multiple-choice selection, a single-choice selection, a star selection, or the like.

In some embodiments, a member application includes a software module for managing a resource. In some embodiments, a resource comprises money, a stock, an IPO, a derivative, a raw material, an employee, a device, a location, software, an algorithm, a database, a document, or the like.

In some embodiments, a member application includes a software module for creating and implementing a business plan. In some embodiments, a business plan is a marketing campaign. In further embodiments, the marketing campaign comprises a promotion, a free trial, an advertisement, a gift with purchase, a rebate, a gift with referral, a free installation with purchase, a free service with purchase, a product rating with gift, free shipping with purchase, a free return with purchase, a raffle, or the like.

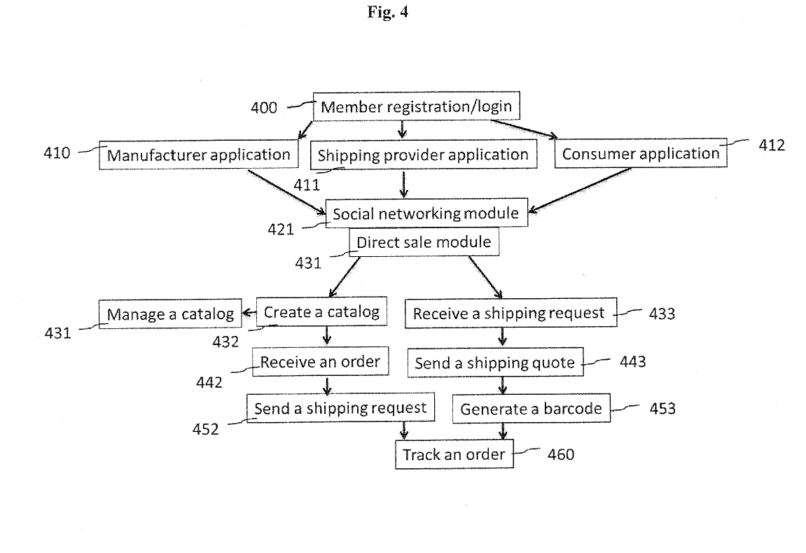

Referring to FIG. 4, in a particular embodiment, a member registers or logs in 400 to a direct sale and social networking platform. The member optionally accesses the manufacturer 410, shipping provider 411, or consumer 412 applications depending on the purpose of his or her login. In this embodiment, the member uses any of the three aforementioned applications to access the social networking module 421 or the direct sale module 431. In this embodiment, the member can create 432 or manage 431 a catalog using the manufacturer application 410. Also in this embodiment, the member receives an order 442 and sends out a shipping request 452 after the order has been confirmed. Also in this embodiment, the member tracks the order 460 using the manufacturer application 410. Also in this embodiment, the member can optionally access the social networking module 421 to communicate with other users. Further in this embodiment, using the shipping provider application 433, the member receives a shipping request 443, and sends out a shipping quote 443 with detailed information in response. Also in this particular embodiment, the member optionally accesses the shipping provider application 411, and generates a barcode 453 and track an order 460.

### Administrator Applications

In some embodiments, the platforms, systems, devices, methods, and media described herein include an administrator application. In further embodiments, the administrator application is adapted for use by administrator users. In further applications, the c administrator application includes tools and elements to enable administrator users to administer data of a direct sale platform.

In some embodiments, an administrator is a person, a group of people, or a company that uses the social network. In some embodiments, an administrator is a person, a group of people, or a company that uses a direct sale platform. In some embodiments, an administrator application includes a software module for creating or managing a database. In some embodiments, a database is of a manufacturer, a shipping provider, a consumer, a product, a catalog, a profile, a rating, a user, a group, or combinations of the same. In further embodiments, the manufacturer is a person, a group of people, or a company that manufactures products for sale. In further embodiments, the shipping provider is a person, a group of people, or a company that sales and fulfill shipping services. In further embodiments, the consumer is a person, a group of people, or a company that purchases products, services, or other articles that are legitimate to buy. In further embodiments, the product is a piece of merchandise, service, an animal, a natural article or the like that is legitimate to sell. In further embodiments, the catalog comprises one or more products for sale. In further embodiments, the catalog comprises a name, a price, a catalog number, a series number, a barcode, a photo, a dimension, a color, a size, a composition material, a weight, a function, an expiration date, a feature, a user manual, a written, a graphic, an audio, or a video description of the product. In further embodiments, the profile comprises public or private information of the user that includes name, birthday, height, weight, gender, age, race, job, education, professional activity, award, certificate, blood type, astrology sign, address, phone number, email, fax, website, photos, hobbies, descriptions of self, resume, online activities, company history, company mission, events, blogs, physical store locators, web links to online help, or the like. In some embodiments, a rating comprises a score, a review, a survey, a multiple-choice selection, a single-choice selection, a star selection, or the like. In further embodiments, the rating is of the manufacturer, the shipping provider, the consumer, the product, the catalog, the user, or the group of users. In further embodiments, the user is a person, a company, an organization, a community, a university, a farm, a church, a society, an association, an army, a firm, a team, a club or the like that accesses the direct sale platform as a single entity. In some embodiments, a group comprises one or more users of a direct sale platform. In some embodiments, a group comprises one or more users of a social network.

In some embodiments, an administrator application includes a software module for categorizing. In some embodiments, the categorization is of a manufacturer, a shipping provider, a consumer, a product, a catalog, a profile, a rating, a user, a group, or combinations of the same.

In some embodiments, an administrator application includes a software module for generating a data analytic. In some embodiments, a data analytic is of a manufacturer, a shipping provider, a consumer, a product, a catalog, a profile, a rating, a user, a group, or combinations of the same. In further embodiments, the data analytic comprises statistical, mathematical, logistic, logical, economical, computational, empirical, logic, logistic, quantitative, qualitative analysis, or the like.

In some embodiments, an administrator application includes a software module for social networking. In some embodiments, social networking comprises sending or allowing a request to or from a user or a group, communicating with a user or a group, broadcasting to multiple users or groups, or the like. In further embodiments, the request is for joining a group, accessing the profile of a user, communicating with a user or a group, blocking a user or a group, tagging a user or a group, or following a user or a group of users. In further embodiments, a communication is one or more selected from a web posting, a text message, a graphic message, a voice message, a video message, an email, or an online chat.

### Overview

In some embodiments, the platforms, systems, media, and methods described herein include web applications (including feeds and widgets associated therewith), mobile applications, combinations thereof, or uses of the same. For example, in some embodiments, the platforms, systems, media, and methods described herein include a web application with software modules configured to allow a user to create and manage a profile (indicating a user type) and to search (or otherwise locate) and connect with other users to form a network of users. In further embodiments, a web application includes software modules configured to allow a user to generate a barcode (indicating a barcode type), generate a shipping request, bid on a shipping request generated by another, receive shipping requests, and rate the services of other users. By way of further example, in some embodiments, the platforms, systems, media, and methods described herein include a mobile application with software modules configured to allow a user to generate barcodes, scan barcodes, prepare delivery routes, gather signatures from shipment recipients, and rate the services of other users.

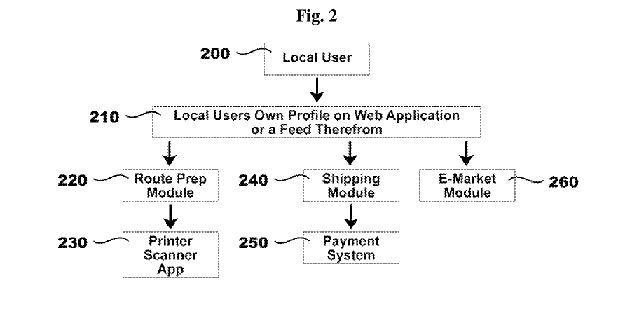

Referring to FIG. 2, in a particular embodiment, a local user 200 has a unique profile 210 associated with a web application. From the web application, the user optionally accesses a route preparation module 220, which is in communication with a printer scanner application 230. From the web application, the user also optionally accesses a shipping module 240, which is in communication with a payment system 250. The user also optionally accesses an e-marketing module 260.

### Profiles

In some embodiments, the platforms, systems, media, and methods described herein include profiles, or use of the same. In further embodiments, the platforms, systems, media, and methods described herein include a software module configured to allow a user to create and manage a profile, or use of the same. In some embodiments, a profile comprises stored information about a user and a visual display of data associated with a specific user. In further embodiments, a profile refers to the explicit digital representation of a user's identity within a computer-based application. As such, in still further embodiments, a profile is used to store the description of the characteristics of a user. This information can be exploited by systems taking into account the user's characteristics and preferences.

A profile suitably includes a wide range of information about a user. In various embodiments, a profile comprises, by way of non-limiting examples, a user name, a user type, an operating area, insurance information, ratings, description of services, and the like. In further embodiments, a user type is either a production user type or a freight user type. For example, production user types include, in some embodiments, manufacturers and suppliers. By way of further example, freight user types include, in some embodiments, freight forwarders and freight transporters.

### Shipping Requests

In some embodiments, the platforms, systems, media, and methods described herein include shipping requests, or use of the same. In further embodiments, the platforms, systems, media, and methods described herein include a software module configured to allow a user to generate shipping requests, or use of the same. A shipping request described herein suitably includes a wide range of information. In various embodiments, a shipping request suitably includes, by way of non-limiting examples, a shipping barcode, one or more parcel barcodes, an origin, one or more destinations, a description of the items, an insurance carrier, an insurance value, special shipping instructions, customs information, and the like.

In some embodiments, a shipping request is generated for a particular shipment. In some embodiments, where the user generating the shipping request has a preferred freight shipping user in their network, a shipping request is directed to the preferred freight user. In other embodiments, a shipping request is directed to a bidding module. In such cases, any freight user may bid on the shipping request or a portion of the shipping request.

### Barcodes

In some embodiments, the platforms, systems, media, and methods described herein include a barcode, or use of the same. In further embodiments, the platforms, systems, media, and methods described herein include a software module configured to allow a user to generate barcodes, or use of the same. Many types of barcodes are suitable including, by way of non-limiting examples, linear barcodes (e.g., UPC codes), two-dimensional barcodes (e.g., QR codes and Datamatrix codes), and High Capacity Color Barcodes (HCCB).

In some embodiments, a barcode described herein includes a barcode type. In further embodiments a barcode is a production barcode associated with a particular article in a production process. In further embodiments a barcode is a shipping barcode associated with a particular shipping request. In other embodiments, a barcode is a parcel barcode associated with a particular package. In some embodiments, a shipping barcode is associated with one or more parcel barcodes.

A parcel barcode described herein suitably includes a wide range of information. In various embodiments, a parcel barcode suitably includes, by way of non-limiting examples, a shipping barcodes, an origin, a destination, a description of the items, an insurance carrier, an insurance value, special shipping instructions, customs information, vehicle loading information, and the like.

A shipping barcode described herein suitably includes a wide range of information. In various embodiments, a shipping barcode suitably includes, by way of non-limiting examples, identification of one or more parcels, one or more parcel barcodes, an origin, one or more destinations, a description of the items, an insurance carrier, an insurance value, special shipping instructions, customs information, vehicle loading information, and the like.

### Ratings

In some embodiments, the platforms, systems, media, and methods described herein include a user ratings, or use of the same. In further embodiments, the platforms, systems, media, and methods described herein include a software module configured to allow a user to rate the services or other users, or use of the same. For example, in various embodiments, a production user rates the services of a freight user, a freight user rates the services of a production user, a production user rates the services of another production user, or a freight user rates the services of another freight user.

In various embodiments, a software module configured to allow a user to rate the services or other users offers users a wide array of suitable rating methods. In some embodiments, a user rates the services of others by responding to a survey. In various embodiments, a survey suitably includes about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more questions.

In some embodiments, a user rates the services of others by voting to indicate preference or degree of preference. In other embodiments, a user votes to indicate disfavor or degree of disfavor. In further embodiments, a user votes selecting from, by way of non-limiting examples, “Yes” or “No,” “Like” or “Dislike,” and “Up” or “Down.” In other embodiments, a user votes by making a selection from a scale. Many scales are suitable for user voting in response to a prompt for a reaction. In various embodiments, suitable scales include, by way of non-limiting examples, 2-step, 3-step, 4-step, 5-step, 6-step, 7-step, 8-step, 9-step, 10-step, 11-step, 12-step, 13-step, 14-step, 15-step, 16-step, 17-step, 18-step, 19-step, 20-step or more scales. In further embodiments, a user votes by selecting from a scale such as, from 1 to 3, from 1 to 5, from 1 to 10, from 1 to 100, from A to C, from A to D, from A to F, and the like. In a particular embodiment, a user votes by selecting from a Likert Scale, including selections such as “Strongly disagree,” “Disagree,” “Neither agree nor disagree,” “Agree,” and “Strongly agree.”

In some embodiments, a user rates the services of others by ranking elements. In further embodiments, a user ranks to indicate preference or degree of preference. In other embodiments, a user ranks to indicate disfavor or degree of disfavor. In some embodiments, a user ranks by assigning one or more numbers (e.g., 1, 2, 3, etc.). In other embodiments, a user ranks by assigning one or more letters (e.g., A, B, C, etc.).

### Networks

In some embodiments, the platforms, systems, media, and methods described herein include user networks, or use of the same. In further embodiments, the platforms, systems, media, and methods described herein include a software module configured to allow a user to connect its profile with those of others to form a network, or use of the same. In some embodiments, the networks disclosed herein comprise user-created affiliations, associations, or partnerships. In some embodiments, a network is created automatically when two users conduct business with each other. In other embodiments, a network is created by an electronic request triggered by a first user (e.g., a networking request, a networking invitation, etc.) followed by an acknowledgement to the request triggered by a second user (e.g., a request or invitation acceptance). Networks are suitably formed between many types of users. In various embodiments, a network is suitably formed between any of: manufacturers, suppliers, freight forwarders, freight transporters, and the like. In some embodiments, the networks disclosed herein are used to create and display network-based shipping requests.

### Exemplary Process Flow

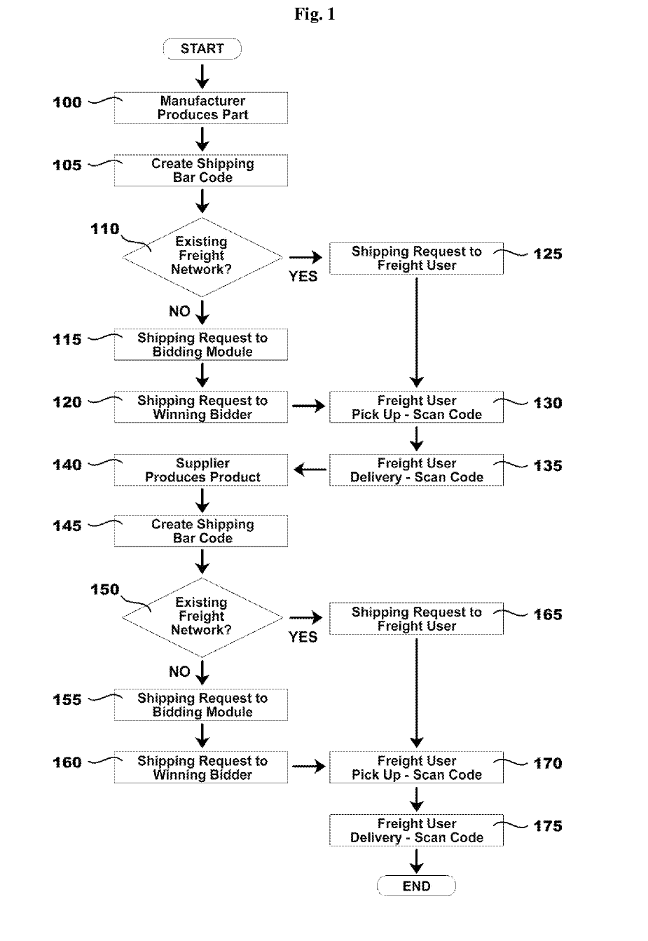

Referring to FIG. 1, in a particular embodiment, a manufacturer produces a part 100 that needs to be shipped to a supplier. The manufacturer creates a shipping barcode 105 associated with the part and a request for shipping. The next step varies depending on whether the manufacturer has a profile in the system connected with a trusted freight company 110. If the manufacturer has a freight company in its network, the shipping request is sent to the fright company 125 who picks up the freight and scans the associated barcode(s). 130.

Continuing to refer to FIG. 1, in a particular embodiment, if the manufacturer does not have a freight company in its network, the shipping request is sent to a bidding module 115. At a bidding module, all out of network fright companies have the option of bidding on the request. The shipping request is sent to the winning bidder 120 who picks up the freight and scans the associated barcode(s). 130. Upon delivery of the part, the driver of the fright company scans the code(s) again 135.

Continuing to refer to FIG. 1, in a particular embodiment, a supplier receiving the part uses it to produce a product 140. Needing to ship the complete product, the supplier creates a shipping barcode 145 and the process is repeated 150-175.

### Extensible Architecture

In some embodiments, the platforms, systems, media, and methods described herein include an extensible architecture, or use of the same. In further embodiments, the application architecture is extensible by addition or removal of access to one or more optional software modules for a particular user. In some embodiments, the subject matter described herein includes business methods such as offering software as a service online. In further embodiments, a particular user optionally purchases access (e.g., in the form of a subscription, or the like) to one or more optional software modules. In still further embodiments, access to a particular software module is dependent, at least in part, upon a user type associated with a user. In various embodiments, user types include production users (manufacturers, suppliers, and the like) and freight users (freight forwarder, trucker, and the like).

TABLE 1
Extensibility based on user type

| Manufacturer/ | Freight Forwarder | |
|---|---|---|
| Supplier User | User | Trucker User |
| Inventory module | Bidding module | Bidding module |
| Bidding module | Shipping module | Shipping module |
| Production module* | Accounting module* | Accounting module* |
| Accounting module* | Sales module* | Route preparation |
| | | module* |
| Fulfillment module* | Emarketing module* | Sales module* |
| Sales module* | | Emarketing module* |
| Emarketing module* | | |

*Optional for user.

TABLE 2
Barcode utilization based on module type

| Shipping Barcode | Parcel Barcode | Production Barcode |
|---|---|---|
| Used by all modules | Used by all modules | Used by fulfillment module |
| | | Used by inventory module |
| | | Used by production module |
| | | Used by accounting module |

### Shipping Module

In some embodiments, the platforms, systems, media, and methods described herein include a shipping module, or use of the same. In some embodiments, a shipping module allows companies and factories to request a shipping quote. In further embodiments, a shipping module allows shipping companies to bid on a job. In still further embodiments, shipping company across bids on jobs across territories as a chaffer can log in with his app anywhere in the world and pick up the shipment.

In some embodiments, a shipping module generates a shipping request for a particular shipment. In further embodiments, a shipping request is directed to an in-network freight user. In other embodiments, a shipping request is directed to a bidding module.

In some embodiments, a shipping module receives a shipping request for a particular shipment. In further embodiments, a shipping request is from in-network production user. In other embodiments, a shipping request is from an out-of-network production user.

### Bidding Module

In some embodiments, the platforms, systems, media, and methods described herein include a bidding module, or use of the same. For example, in some embodiments, a shipping module allows a company to request a shipping quote from its location to a delivery address on an online quoting platform. In further embodiments, the members get a notification and utilize a bidding module to bid on the full shipping and delivery or partially if their service zone do not cover the entire route. In still further embodiments, once the multiple shipping scenarios are listed, these can be sorted so the company can see the best time/money option on a global map. In some embodiments, addresses to drop off and pick up the shipment are given automatically by the shipping companies. In further embodiments, once the shipper accepts the quote he is bound to the quoted costs.

In some embodiments, the system creates barcodes for shipments. In further embodiments, the shipment's ownership it passed on in the system from the shipper that creates the barcode/shipment. In still further embodiments, the shipping company/companies will accept the shipment and the conditions and delivers the goods. Invoices for the shipping services will follow from the shipping company to the shipper. The system is able to automatically create an invoice trial.

In some embodiments, the barcode is captured through a scan from a mobile device using the app and at delivery a signature is captured that proves the delivery. In some embodiments, for added assurance, a picture can be taken by the mobile phone at the time of the delivery and attached with the phone's GPS stamp. In such embodiments, it is possible to track the shipment via the phones GPS and through the last delivery agent. The App features a way to directly contact the actual mobile device to be able to get a real time update.

### Production Module

In some embodiments, a production module tracks the flow of goods in a production facility from the goods receiving through the end of a production process. In further embodiments, a production module tracks the flow of goods in a production facility by scanning in and out the variables in a production cycle. In some embodiments, a production module is set up in calculating the production through a barcode tracking system. In still further embodiments, calculating the production includes generating all types of reports from time/employee, volume of materials/department, production time, waste, cost of production/cost of idling, and the like.

### Inventory Module

In some embodiments, an inventory module tracks inventory through the same barcode system. In further embodiments, having all production batches bar-coded and each production cycle scanned allows a user to determine all types of calculations and to fine-tune the effectiveness of an operation. In some embodiments, an inventory module tracks details including, by way of example, what was used, how much of it was used, who used it, in which process was it used, and this way one can easily build a picture of the operation.

### Fulfillment Module

In some embodiments, the platforms, systems, media, and methods described herein allow a user to create barcodes at will. In further embodiments, the barcode capability allows set up of a warehousing/fulfillment module as the principle of placing and sorting is the same.

### Sales Module

In some embodiments, a sales module allows a user to “book the orders.” In further embodiments, a sales module allows a user to see where the production is carried out, be able to predict delivery times, calculate the necessary cost and effort to produce an order, and the like.

### Accounting Module

In some embodiments, an accounting module is a feature that is added so smaller companies can run their own accounting for a small fee instead of buying an individual software. In further embodiments, an accounting module includes all features such as billing, payroll, profit/loss statement, and the like.

### E-Marketing Module

An e-marketing module is designed to market to the users of the system, which represent a captive audience within an industry. In some embodiments, an e-marketing module allows advertisers to sell to other users of the system. For example, advertisers, in some embodiments, sell to truckers offering anything from winter tires to chassis to discount truck parts. In further embodiments, an e-marketing module presents banners and other advertising at locations of the interface where specific types of users can be offered related products. In one example, an e-marketing module, at the warehouse log in, presents ads running warehouse supplies and the like.

### Route Preparation Module

Currently many transport companies operate within a geographical area. A traditional transport company may have, for example, 10 trucks and 7 or 8 established routes, each driven every business day by a driver. The remaining 2 or 3 trucks are used on a standby basis. Each driver gets to know a geographical area and the clients/industry in that area.

Traditional route preparation techniques are replete with deficiencies. For example, the driver is paid an hourly wage and has to deliver a certain number of packages for the company to break even. There are in every company a number of these routes that simply make no sense to drive it daily as one is losing money on it. By way of further example, the driver can, if he wants to, take a 3 hour lunch break and there is no way to tell—as he knows the area, how hard is to drive it, there is traffic jam, every excuse in the world. Further deficiencies of traditional route preparation involve the interaction of the package and the vehicle. For example, if a route has 80 destinations, that means 80 packages of different sizes/weight. Loading of the delivery vehicle is critical. If one just loads it all in, without any order, then it takes a long time to find the package in the vehicle. Normally, heavy goes in the bottom, light goes in the top. However, this rule is not respected and a light parcel gets damages by a heavy one due to that the delivery vehicle is not packed correctly.

The subject matter described herein implements a GPS system that is based on barcodes to improve the traditional methods for carriers, drivers, and customers. The barcode contains the delivery address. In some embodiments, as soon as one scanned it into the truck wave mobile app, the software calculates out each individual “stop,” where a delivery has to be made, and with this system one can build a route. In further embodiments, one can see in advance how many packages need to be on a route to make it viable for the company, how long it will take, how much fuel is will used. As a result, a fright company can use any driver on the route as they only need to follow the pre-programmed GPS.

Commercial GPS devices are available that can calculate up to 5 destinations and these are fixed, pre-programmed routes. Otherwise one has to type in each address by hand, which is prone to mistakes. The capacity to calculate routes is currently limited by the computing power of the GPS; however, if the same process runs on a server with much higher computing power, the destinations in the right order are “loaded” into the app's GPS and it takes no time as the “sorting” of the delivery addresses against a map with millions of variables is done at the server level and not in a limited GPS device. Even if a GPS device would be available that could handle unlimited addresses, a user would still have to sit and manually enter each address. The inventions described herein allow a user to scan the barcode and the system puts the delivery address in the right order.

Moreover, the subject matter described herein includes a programmable process, wherein the system can tell where to put the package based on size/weight by programming destinations in the vehicle—like shelf 1 shelf 2, floor back of the van, on the floor front of the van, and the like. The same is true if a freight user only delivers pallets that have to be loaded by “last pallet in is the first pallet out.”

In trucking goods it is important that a route is planned correctly otherwise one is driving around uselessly and it is wasting time and burning diesel for nothing. The ideal scenario is that if a driver has to make 20 stops to deliver he takes the stops one after the other in the right sequence by the “last piece in the truck is the first piece out” and in the fastest time/shortest route scenario.

The route prep module, in some embodiments, plans the route according to the delivery addresses eliminating the “think” factor. This will allow any driver to know: how much to load on his vehicle, how many miles he will drive that day, load according to the amount of time he wants to work, when there is a need to take a break and where can he stop, fuel use and need for a trip, cost of the day, plus many other benefits as one can calculate exact costs of operation automatically at the beginning of each day.

In some embodiments, a route prep module comprises a distinct mobile app that is connected to a GPS program which the driver can follow as his own in-car GPS. In further embodiments, a route prep module allows a driver to change route, recalculate the driving sequence, and the like.

### Digital Processing Device

In some embodiments, the platforms, media, methods and applications described herein include a digital processing device, a processor, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, media, methods and applications described herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, media, methods and applications described herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, media, methods and applications described herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of barcode, route, parcel, user, or network information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

1. A computer-implemented platform, system, or device for a direct sale to a user or a group of users comprising a processor configured to provide a consumer application comprising:
a) a software module for the user or the group of users to purchase a product directly from a manufacturer of the product, provided that the user or the group of users has the option to purchase the product from at least two manufacturers;
b) a software module for selecting a shipping service from a shipping provider for the product, provided that shipping is from the manufacturer to the user or the group of users, and provided that the user or the group of users has the option to purchase the shipping service from at least two shipping providers;
c) a software module for tracking the product through the manufacturing and shipping processes; and
d) a software module for social networking, provided that social networking comprises directly connecting to the manufacturer, the shipping provider, a different user, or a different group of users.

2. The platform of claim 1, provided that the product is a piece of merchandise or a service.

3. The platform of claim 1 that further comprises a software module for creating or managing a profile of the user or the group of users, provided that the profile comprises a name, an address, a phone number, an email, a website, or a description.

4. (canceled)

5. The platform of claim 1 that further comprises a software module for searching for the product, a catalog, a rating, the user, or the group of users within a database of the platform or a third-party.

6. (canceled)

7. (canceled)

8. The platform of claim 5, provided that the catalog comprises a name, a catalog number, a series number, a barcode, a description, or a price of the product.

9. The platform of claim 1 that further comprises a software module for comparing price of the product, provided that the price comprises cost of the product, national tax, customs tax, cost of insurance, or cost of shipping.

10. (canceled)

11. The platform of claim 1 that further comprises a software module for viewing or adding a rating of the product, a catalog, the user, or the group of users.

12. The platform of claim 1 that further comprises a software module for placing an order.

13. The platform of claim 1 that further comprises a software module for receiving a shipping quote from a shipping provider.

14. The platform of claim 1 that further comprises a software module for sending a shipping request to a shipping provider, provided that the shipping provider is selected by the user or the group of users, and the shipping request comprises the recipient name, delivery address, delivery time, shipping cost, or a shipping route.

15. (canceled)

16. The platform of claim 1, provided that the tracking is via a unique barcode.

17. (canceled)

18. The platform of claim 1 that further comprises a software module for requesting real-time customer service, provided that the customer service comprises an inquiry, maintenance, a repair, an exchange, a replacement, a return, or a refund.

19. (canceled)

20. (canceled)

21. The platform of claim 1 that further comprises a software module for managing and analyzing data, provided that data are related to the direct sale.

22. The platform of claim 1, provided that social networking influences the shopping, selling, shipping, or tracking of the direct sale.

23. The platform of claim 1, provided that social networking influences the preference in selecting the manufacturer, the product, the shipping provider, the shipping service, the different user, or the different group of users of the direct sale.

24. The platform of claim 1, provided that social networking comprises sending or allowing a request to or from the user or the group of users, or communicating with the user or the group of users.

25. The platform of claim 22, provided that the request is for joining the group of users, accessing a profile of the user, communicating with the user or the group of users.

26. The platform of claim 22, provided that the communication is a posting, a text message, a graphic message, a voice message, an email, or an online chat.

27. A computer-implemented method of a direct sale to a user or a group of users that comprises:
a) providing, by a computer, an interface for purchasing a product directly from a manufacturer, provided that the user or the group of users has the option to purchase the product from at least two manufacturers;
b) providing, by the computer, an interface for selecting a shipping service from a shipping provider for the product, provided that the shipping is from the manufacturer to the user or the group of users, and provided that the user or the group of users has the option to purchase the shipping service from at least two shipping providers;
c) providing, by the computer, an interface for tracking the product from the manufacturer to the user or the group of users; and
d) providing, by the computer, an interface for accessing a social network, provided that social networking comprises directly connecting to the manufacturer, the shipping provider, a different user, or a different group of users.

28. Non-transitory computer-readable storage media encoded with a computer program including instructions executable by a processor to create a consumer application comprising:
a) a software module for a user or a group of users to purchase a product directly from a manufacturer, provided that the user or the group of users has the option to purchase the product from at least two manufacturers;
b) a software module for selecting a shipping service from a shipping provider for the product, provided that the shipping is from the manufacturer to the user or the group of users, and provided that the user or the group of users has the option to purchase the shipping service from at least two shipping providers;
c) a software module for tracking the product from the manufacturer to the user or the group of users; and
d) a software module for social networking, provided that social networking comprises directly connecting to the manufacturer, the shipping provider, a different user, or a different group of users.
